(19) United States
(12) Patent Application Publication
(10) Pub. No.: US 2025/0327946 A1
(43) Pub. Date: Oct. 23, 2025

(54) CAPTURING TRANSIENT EFFECTS IN SIMULATIONS OF FRACTURED SUBSURFACE MODELS

(71) Applicant: CHEVRON U.S.A. INC., San Ramon, CA (US)

(72) Inventors: Alvaro Jose REY, Denver, CO (US); Hector Emilio BARRIOS MOLANO, Houston, TX (US); Shihao WANG, Houston, TX (US)

(73) Assignee: CHEVRON U.S.A. INC., San Ramon, CA (US)

(21) Appl. No.: 18/969,071

(22) Filed: Dec. 4, 2024

Related U.S. Application Data
(60) Provisional application No. 63/635,086, filed on Apr. 17, 2024.

(51) Int. Cl. G01V 20/00; G06F 30/27; G06F 30/28; G06F 111/10

(52) U.S. Cl. CPC G01V 20/00; G06F 30/27; G06F 30/28; G06F 2111/10

(57) ABSTRACT

A method is described for of simulating fluid flow. The method may include obtaining a reservoir model for a subsurface volume of interest that comprises at least one fracture. The reservoir model is in coarse scale, and the reservoir model includes a plurality of matrix-fracture connections. The method may include performing a simulation and generating simulation output using the obtained reservoir model to solve for fluid flow of the subsurface volume of interest that comprises the at least one fracture. For each time step of the simulation, the method includes calculating the transmissibility for each matrix-fracture connection using the obtained simulation data and a transmissibility modification method and modifying a previous transmissibility of each matrix-fracture connection in the reservoir model with the corresponding transmissibility calculated using the transmissibility modification method. The calculated transmissibility for each matrix-fracture connection changes over simulation time. The method may be executed by a computer system.

### CROSS-REFERENCE TO RELATED APPLICATIONS

This application claims priority to U.S. Provisional Application Ser. No. 63/635,086, filed on Apr. 17, 2024, the contents of which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for simulating fluid flow for a subsurface volume of interest that comprises at least one fracture.

### BACKGROUND

Simulations are routinely used in the oil and gas industry for decision making. Grid resolution, such as coarse scale resolution vs fine scale resolution, has a great impact on simulation of unconventional reservoirs, such as shale & tight (S&T) reservoirs. Coarse-resolution models typically ignore the transient nature of production at early times. Also, complex physics processes typically require fine grid resolutions to be able to capture the processes accurately, but the use of higher resolution models is typically prohibitive as simulation time would be impractical. Unfortunately, other approaches have their shortcomings compared to coarse simulation models, thus limiting the refinement level that could be applied.

There is a need to capture near-fracture transient effects that occur during the coarse-resolution simulation of unconventional reservoirs.

### SUMMARY

In accordance with some embodiments, a method of simulating fluid flow for a subsurface volume of interest that comprises at least one fracture is disclosed. The method may include obtaining a reservoir model for a subsurface volume of interest that comprises at least one fracture. The reservoir model is in coarse scale, and the reservoir model comprises a plurality of matrix-fracture connections. The method may further include performing a simulation and generating simulation output using the obtained reservoir model to solve for fluid flow of the subsurface volume of interest that comprises the at least one fracture. The simulation includes a plurality of time steps, and for each time step of the simulation, the method includes: (i) obtaining simulation data for calculating a transmissibility for each matrix-fracture connection, (ii) calculating the transmissibility for each matrix-fracture connection using the obtained simulation data and a first diffusivity-based transmissibility modification method, wherein the calculated transmissibility for each matrix-fracture connection changes over simulation time, (iii) modifying a previous transmissibility of each matrix-fracture connection in the reservoir model with the corresponding transmissibility calculated using the first diffusivity-based transmissibility modification method, and (iv) solving for fluid flow using the modified reservoir model.

In accordance with some embodiments, a method of simulating fluid flow for a subsurface volume of interest that comprises at least one fracture is disclosed. The method may include obtaining a reservoir model for a subsurface volume of interest that comprises at least one fracture. The reservoir model is in coarse scale, and the reservoir model comprises a plurality of matrix-fracture connections. The method may further include performing a simulation and generating simulation output using the obtained reservoir model to solve for fluid flow of the subsurface volume of interest that comprises the at least one fracture. The simulation includes a plurality of time steps, and for each time step of the simulation, the method includes: (i) obtaining simulation data for calculating a transmissibility for each matrix-fracture connection, (ii) calculating the transmissibility for each matrix-fracture connection using the obtained simulation data and a second diffusivity-based transmissibility modification method, wherein the calculated transmissibility for each matrix-fracture connection changes over simulation time, (iii) modifying a previous transmissibility of each matrix-fracture connection in the reservoir model with the corresponding transmissibility calculated using the second diffusivity-based transmissibility modification method, and (iv) solving for fluid flow using the modified reservoir model.

In accordance with some embodiments, a method of simulating fluid flow for a subsurface volume of interest that comprises at least one fracture is disclosed. The method may include obtaining a reservoir model for a subsurface volume of interest that comprises at least one fracture. The reservoir model is in coarse scale, and the reservoir model comprises a plurality of matrix-fracture connections. The method may further include performing a simulation and generating simulation output using the obtained reservoir model to solve for fluid flow of the subsurface volume of interest that comprises the at least one fracture. The simulation includes a plurality of time steps, and for each time step of the simulation, the method includes: (i) obtaining simulation data for calculating a transmissibility for each matrix-fracture connection, (ii) calculating the transmissibility for each matrix-fracture connection using the obtained simulation data and a machine learning-based transmissibility modification method, wherein the calculated transmissibility for each matrix-fracture connection changes over simulation time, (iii) modifying a previous transmissibility of each matrix-fracture connection in the reservoir model with the corresponding transmissibility calculated using the machine learning-based transmissibility modification method, and (iv) solving for fluid flow using the modified reservoir model.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1A illustrates an example system of simulating fluid flow for a subsurface volume of interest that comprises at least one fracture. FIG. 1B illustrates an example method of simulating fluid flow for a subsurface volume of interest that comprises at least one fracture. FIG. 1C illustrates another example method of simulating fluid flow for a subsurface volume of interest that comprises at least one fracture. FIG. 1D illustrates another example method of simulating fluid flow for a subsurface volume of interest that comprises at least one fracture.

FIG. 2A illustrates a schematic of a fracture and matrix block and analytical pressure distribution. FIG. 2B illustrates a schematic of a fracture and matrix block for reservoir simulation.

FIG. 3 illustrates a ML-based transmissibility estimation workflow using two ANNs.

FIG. 4 illustrates a planar fracture case showing well location, fracture, and grid cross-section. Property displayed is pressure at the end of simulation for a coarse model (left) and a refined model (right).

FIG. 5 illustrates liquid production rate (left) and oil production cumulative (right) for the planar fracture case.

FIG. 6 illustrates liquid production rate in log-log scale for the planar fracture case.

FIG. 7 illustrates elapsed CPU time for the planar fracture case.

FIG. 8 illustrates hydraulic fracture geometry and grid cross-section for grids used in the complex EDFM case, including coarse grid (left) and fine with two levels of LGRs (right).

FIG. 9 illustrates liquid production rate (left) and liquid production cumulative (right) for the complex EDFM case.

FIG. 10 illustrates liquid production rate in log-log scale for the complex EDFM case.

FIG. 11 illustrates elapsed CPU time for the complex EDFM case.

FIG. 12 illustrates time step size for the complex EDFM case for the coarse grid with the Diff-based A and the Olorode and Rashid (2022) approaches.

FIG. 13 illustrates pressure distribution at 720 days (A) coarse model with one matrix cell (left) and (B) Refined model with 500 matrix cells (right).

FIG. 14A illustrates a diagram of a 1D Explicit Fracture case with a ML-based transmissibility estimation workflow using two ANNs. FIG. 14B illustrates error while training the ANNs for the training set (loss) and validation set (val_loss) for (left) refined model ANN and (right) coarse model ANN.

FIG. 15 illustrates liquid production rate (left) and cumulative production (right) comparing the coarse model, refined model, coarse model with analytical modification and coarse model with ML-based modification.

FIG. 16 illustrates liquid production rate (left) and cumulative production (right) when compaction is included.

Like reference numerals refer to corresponding parts throughout the drawings.

### DETAILED DESCRIPTION OF EMBODIMENTS

The use of embedded discrete fracture modeling (EDFM) for simulation of unconventional reservoirs offers several advantages over other approaches such as dual continuum or discrete fracture modeling (DFM). EDFM can model complex geometry of fractures better than dual continuum, it uses more efficient grids than DFNs and leverage the use of non-neighbor connections present in many simulators, hence it could be implemented in existing reservoir simulators. EDFM models the matrix and fractures as two separate grids connecting them through matrix-fracture (MF) connections. This transmissibility assumes a linear distribution of pressure inside the matrix block, as well as pseudo-steady state flow. If the matrix cells connected to the fracture are sufficiently small, the assumption for pseudo-steady state flow in MF transmissibility is valid. However, as the matrix cell size increases and matrix permeability decreases, the effects of transient flow are more important and are present for longer times. Additionally, grid resolution has a great impact on Gas Oil Ratio (GOR) profiles on fluids close to bubble point, small grid cells connected to the fractures are able to capture the sharp pressure decline and the appearance of gas. On the contrary, the pressure changes in coarse grid cells would be less drastic and no gas would form. Furthermore, complex physics processes, such as, chemical injection or hydrocarbon gas injection (HCGI) requires fine grid resolutions (about 1 ft) to be able to capture the process accurately. Current field model resolution for unconventional reservoirs is close to 50 ft, with millions of fracture elements. This makes the use of higher resolution models prohibitive because simulation time would be impractical.

One proposed solution to account for the transient effects in unconventional reservoir simulation is to use local grid refinements (LGR). In this approach, only the cells around the fractures are refined, which are the places where most of the transient changes occur. However, given the number grid cells intersected by fracture elements in unconventional reservoir models, the number of refined cells will be significant, hence there is a considerable overhead compared to coarse simulation models, thus limiting the refinement level that could be applied.

Another approach is to use the multiple interacting continua method (MINC). MINC is a generalization of the dual continuum approach. MINC discretizes the matrix cells that are connected to fractures based on the proximity to the fracture. The discretization of the matrix captures more accurately the transient effects happening closer to the fracture. This method, however, requires more effort to implement and not all reservoir simulators could easily use it.

Zimmerman et al. (1993) proposed an analytical modification to transmissibility for dual porosity models. This modification accounted for the transient effects of the early times and the pseudo-steady flow at late times. They developed an expression for a transmissibility multiplier. They assumed a spherical matrix block and applied the approach proposed by Vermeulen (1953) to approximate the analytical solution. Olorode and Rashid (2022) applied this approach to MF connections in EDFM models. The transmissibility multiplier is given by

$${T}_{mult} = \frac{2 {Φ}_{i n i} - ( {Φ}_{m} + {Φ}_{f} )}{2 ( {Φ}_{i n i} - {Φ}_{m} )} \qquad ( 1 )$$

where Φᵢₙᵢ, Φₘ and Φ_{f} are the initial potential, the potential in the matrix, and the potential in the fracture, respectively. The following items are each incorporated by reference: (a) Zimmerman, R. W., Chen, G., Hadgu, T. et al. 1993. A numerical dual-porosity model with semianalytical treatment of fracture/matrix flow. Water Resour. Res. 29 (7): 2127-2137. doi: https://doi.org/10.1029/93WR00749, (b) Vermeulen, T. 1953. Theory for irreversible and constant-pattern solid diffusion. Industrial & Engineering Chemistry, 45 (8): 1664-1670. doi: https://doi.org/10.1021/ie50524a025, and (c) Olorode, O. and Rashid, H. 2022. Analytical modification of EDFM for transient flow in tight rocks. Sci Rep 12, 22018. https://doi.org/10.1038/s41598-022-26536-w.

Described below are methods, systems, and computer readable storage media that provide a manner of simulating fluid flow for a subsurface volume of interest that comprises at least one fracture.

In accordance with some embodiments, a method of simulating fluid flow for a subsurface volume of interest that comprises at least one fracture is disclosed. The method may include obtaining a reservoir model for a subsurface volume of interest that comprises at least one fracture. The reservoir model is in coarse scale, and the reservoir model comprises a plurality of matrix-fracture connections. The method may further include performing a simulation and generating simulation output using the obtained reservoir model to solve for fluid flow of the subsurface volume of interest that comprises the at least one fracture. The simulation includes a plurality of time steps, and for each time step of the simulation, the method includes: (i) obtaining simulation data for calculating a transmissibility for each matrix-fracture connection, (ii) calculating the transmissibility for each matrix-fracture connection using the obtained simulation data and a first diffusivity-based transmissibility modification method, wherein the calculated transmissibility for each matrix-fracture connection changes over simulation time, (iii) modifying a previous transmissibility of each matrix-fracture connection in the reservoir model with the corresponding transmissibility calculated using the first diffusivity-based transmissibility modification method, and (iv) solving for fluid flow using the modified reservoir model.

In accordance with some embodiments, a method of simulating fluid flow for a subsurface volume of interest that comprises at least one fracture is disclosed. The method may include obtaining a reservoir model for a subsurface volume of interest that comprises at least one fracture. The reservoir model is in coarse scale, and the reservoir model comprises a plurality of matrix-fracture connections. The method may further include performing a simulation and generating simulation output using the obtained reservoir model to solve for fluid flow of the subsurface volume of interest that comprises the at least one fracture. The simulation includes a plurality of time steps, and for each time step of the simulation, the method includes: (i) obtaining simulation data for calculating a transmissibility for each matrix-fracture connection, (ii) calculating the transmissibility for each matrix-fracture connection using the obtained simulation data and a second diffusivity-based transmissibility modification method, wherein the calculated transmissibility for each matrix-fracture connection changes over simulation time, (iii) modifying a previous transmissibility of each matrix-fracture connection in the reservoir model with the corresponding transmissibility calculated using the second diffusivity-based transmissibility modification method, and (iv) solving for fluid flow using the modified reservoir model.

In accordance with some embodiments, a method of simulating fluid flow for a subsurface volume of interest that comprises at least one fracture is disclosed. The method may include obtaining a reservoir model for a subsurface volume of interest that comprises at least one fracture. The reservoir model is in coarse scale, and the reservoir model comprises a plurality of matrix-fracture connections. The method may further include performing a simulation and generating simulation output using the obtained reservoir model to solve for fluid flow of the subsurface volume of interest that comprises the at least one fracture. The simulation includes a plurality of time steps, and for each time step of the simulation, the method includes: (i) obtaining simulation data for calculating a transmissibility for each matrix-fracture connection, (ii) calculating the transmissibility for each matrix-fracture connection using the obtained simulation data and a machine learning-based transmissibility modification method, wherein the calculated transmissibility for each matrix-fracture connection changes over simulation time, (iii) modifying a previous transmissibility of each matrix-fracture connection in the reservoir model with the corresponding transmissibility calculated using the machine learning-based transmissibility modification method, and (iv) solving for fluid flow using the modified reservoir model.

This disclosure includes three methods to capture near-fracture transient effects that occur during the coarse-resolution simulation of unconventional reservoirs. The near-fracture region is the region of the reservoir close to the fracture plane. The near-fracture region depends on the process and time, and it could be few inches, few feet, etc. (e.g., 0.1 ft-25 ft) in size. The three methods aim to enhance coarse-resolution simulation models to accurately capture the production behavior that occurs during the initial transient times by changing the transmissibility of the MF connections through time, without significantly increasing the computational time.

Advantageously, the three methods account for transient effects in reservoir simulation for unconventional reservoirs. The three methods modify the transmissibility between matrix-fracture connections over time. The first two methods (i.e., Diff-based A method and Diff-based B method) include an analytical expression based on a single-phase pressure diffusivity model. These two methods compute the new transmissibility over time based on the coarse grid model properties. These two methods were tested using models with different complexity and compared them with refined models. The third method (i.e., ML-based method) uses two artificial neural networks. The first network was trained using the refined grid to predict fluid flow at the fracture face. The second network was trained as a reverse proxy on the coarse model to compute transmissibility from flow rate.

The first two methods (i.e., Diff-based A method and Diff-based B method) use an analytical solution with a setup closer to what is found in unconventional reservoirs. The third method (i.e., ML-based method) leverages machine learning methods to compute the new transmissibility. These methods were applied in unconventional reservoir simulation models of different complexity (i.e., one-dimensional explicit matrix-fracture, small scale Embedded Discreet Fracture Modeling (EDFM), and single-stage hydraulic fracture EDFM with several thousand matrix-fracture connections) and compared them with existing methods such as global or local grid refinements.

Advantageously, the analytical modifications provide accurate results during the early times and transition smoothly to the pseudo steady state of late times, while using only a fraction of the grid cells and reducing CPU time up to two orders of magnitude compared with the refined models.

Furthermore, the ML-based method was tested in a one-dimensional case and compared with the refined and analytical model shown in this disclosure. Advantageously, it was observed that when the coarse model fits within the assumptions of the single-phase pressure diffusivity model, both approaches give close results. Advantageously, it was shown that when rock compaction is included, the ML-based method can capture the additional physics and produces a more accurate production profile than the analytical-based modification.

These three transient transmissibility modification methods improve the accuracy of coarse resolution simulation of unconventional reservoirs at early times. Advantageously, the analytical modifications of transmissibility provide a good approximation for models that lie outside the assumption of the single-phase pressure diffusivity model and due to its simplicity to implement, could be used as an improvement to static transmissibility coarse models. Additionally, the ML-based method was able to use artificial neural networks to link high-resolution behavior with coarse-resolution properties. Finally, these methods could be extended to other applications such as geothermal processes and DPDK models.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments. Of note, for simplicity and case of understanding, the terminology Diff-based A method and the like, Diff-based B method and the like, and ML-based method and the like are used herein to distinguish between these three transmissibility modifying methods. However, the invention is not limited to the embodiments of the Diff-based A method and the like described herein. The invention is not limited to the embodiments of the Diff-based B method and the like described herein. The invention is not limited to the embodiments of the ML-based A method and the like described herein.

The methods and systems of the present disclosure may, in part, use one or more models that are machine-learning algorithms. These models may be supervised learning algorithms are trained using labeled data (i.e., training data) which consist of input and output pairs. By way of example and not limitation, supervised learning algorithms may include classification and/or regression algorithms such as neural networks, generative adversarial networks, linear regression, etc. Although the present disclosure may name specific models, those of skill in the art will appreciate that any model that may accomplish the goal may be used.

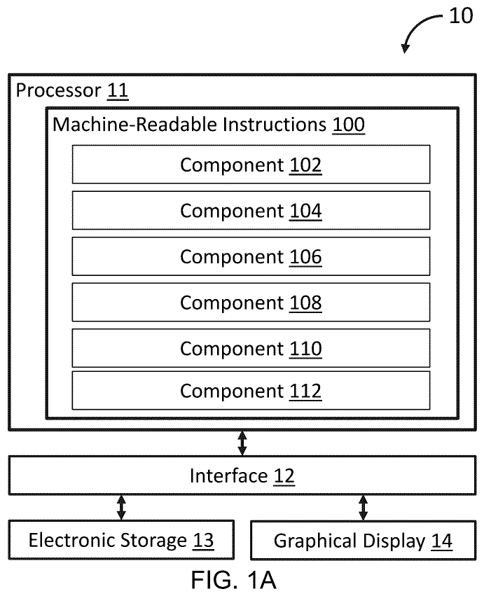

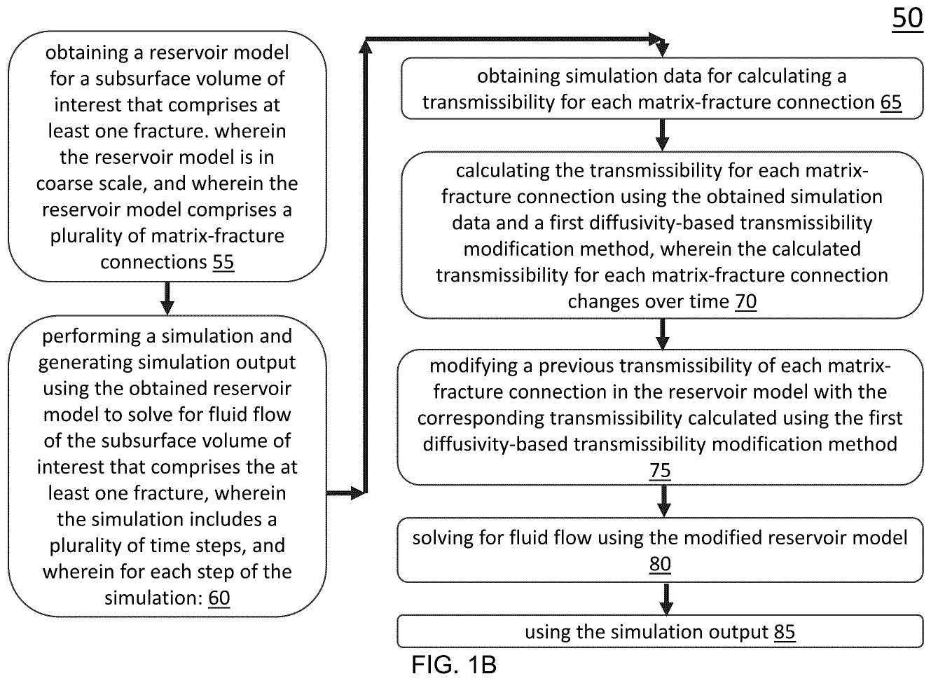

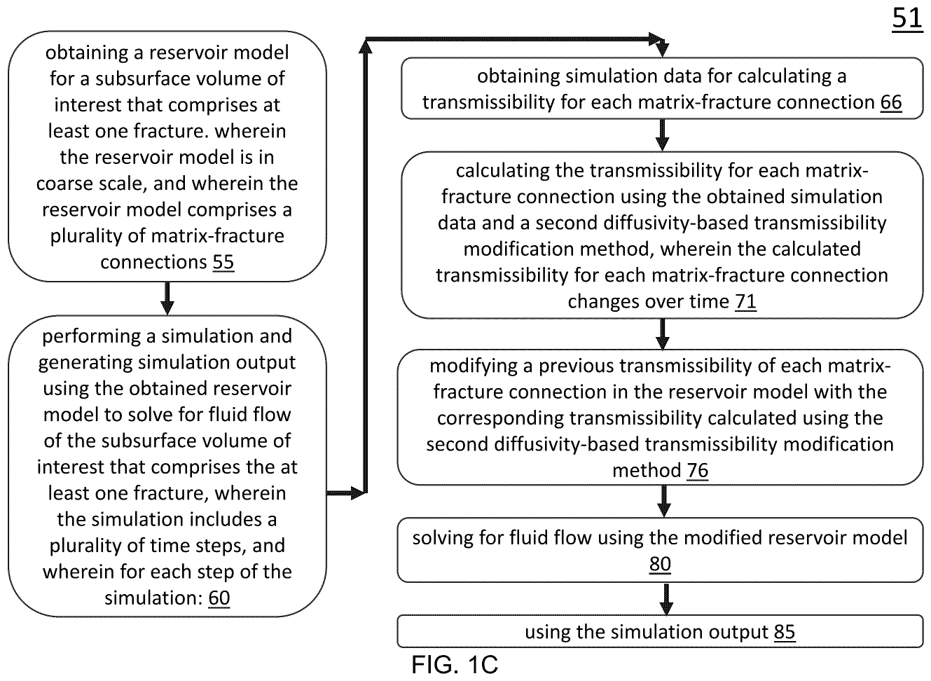

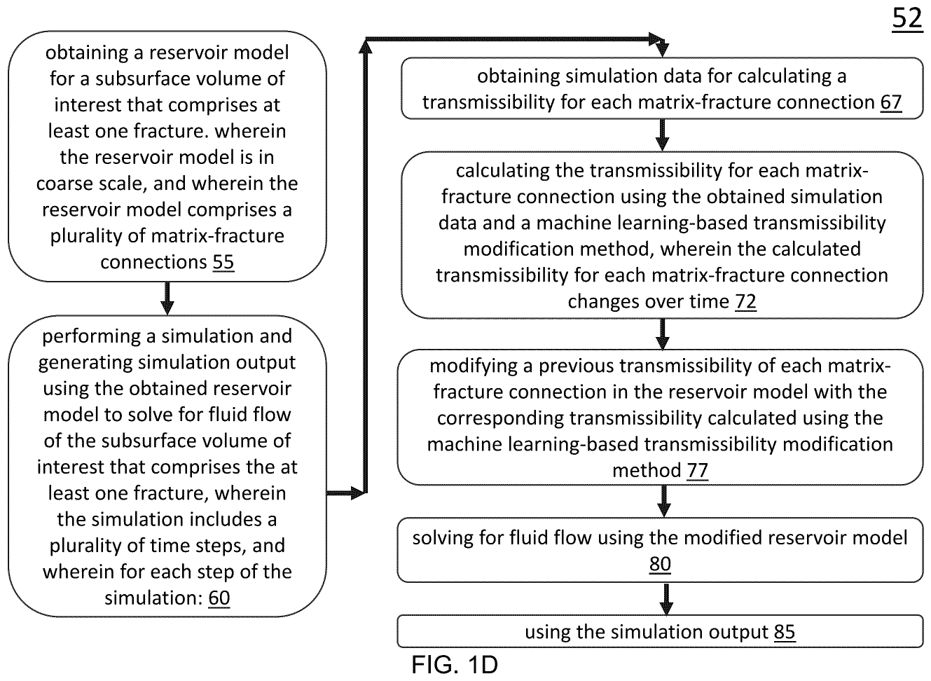

The methods and systems of the present disclosure may be implemented by a system and/or in a system, such as a system 10 shown in FIG. 1A. The system 10 may include one or more of a processor 11, an interface 12 (e.g., bus, wireless interface), an electronic storage 13, a graphical display 14, and/or other components.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to input (e.g., reservoir geometry, reservoir properties, well and completion information, matrix-fracture connections for the entire simulation method, input calibration factor for the Diff-based A and Diff-based B methods, and/or input ANN weights and topology definition for the ML-based method) and/or other information. For example, the electronic storage 13 may store information relating to output (e.g., output flow rates, pressures, phase saturations for the entire simulation method, output computed transmissibility for the Diff-based A method, output computed transmissibility, effective simulation time for the Diff-based B method, and/or output computed transmissibility, ANN outputs for the ML-based method) and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1A as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to output flow rates, pressures, phase saturations for the entire simulation method, output computed transmissibility for the Diff-based A method, output computed transmissibility, effective simulation time for the Diff-based B method, and/or output computed transmissibility, ANN outputs for the ML-based method), intermediate & final results, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate fluid flow simulation for a subsurface volume of interest that comprises at least one fracture. The machine-readable instructions 100 may include one or more computer program components. The machine-readable instructions 100 may include a reservoir model component 102, a simulation component 104, a simulation data component 106, a transmissibility calculation component 108, a transmissibly modification component 110, a fluid flow component 112, and/or other computer program components.

It should be appreciated that although computer program components are illustrated in FIG. 1A as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for case of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the reservoir component 102 may be configured to obtain a reservoir model for a subsurface volume of interest that comprises at least one fracture. The reservoir model is in coarse scale. The reservoir model comprises a plurality of matrix-fracture connections

The simulation component 104 may be configured to perform a simulation and generate simulation output using the obtained reservoir model to solve for fluid flow of the subsurface volume of interest that comprises the at least one fracture. The simulation includes a plurality of time steps, and for each time step of the simulation, the simulation component 104 may communicate with the components 106, 108, 110, and 112. The simulation component 104 (as well as the components herein such as the components 106, 108, 110, and 112) may utilize a simulator, such as a reservoir similar (e.g., INTERSECT reservoir simulator.)

The simulation data component 106 may be configured to obtain simulation data for calculating a transmissibility for each matrix-fracture connection.

The transmissibility calculation 108 may be configured to calculate the transmissibility for each matrix-fracture connection using the obtained simulation data and a a transmissibility modification method (e.g., Diff-based A method or Diff-based B method or ML-based method). The calculated transmissibility for each matrix-fracture connection changes over simulation time.

The transmissibly modification component 110 may be configured to modify a previous transmissibility of each matrix-fracture connection in the reservoir model with the corresponding transmissibility calculated using the transmissibility modification method (e.g., Diff-based A method or Diff-based B method or ML-based method).

The fluid flow component 112 may be configured to solve for fluid flow using the modified reservoir model.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

Machine learning has revolutionized various fields by enabling computers to learn from data and make informed decisions. Traditional algorithms, while effective, often rely on fixed rules and predefined routines. In contrast, the proposed system harnesses the power of machine learning architectures that transcend these limitations.

A system of simulating fluid flow for a subsurface volume of interest that comprises at least one fracture using machine learning may include a plurality of artificial neural networks, which include multiple layers of interconnected neurons mimicking the human brain's neural structure. System 10 applies these architectures to calculate transmissibilities for matrix-fracture connections, analyze data sets, uncover hidden patterns, and solve intricate problems. By surpassing predefined routines, the system achieves results, including capturing transient effects, that extend well beyond abstract ideas and mental processes.

The adaptive, dynamic nature and utilization of advanced architectures redefine the boundaries of computational capabilities. By design, machine learning architectures function outside of any preprogrammed routines. Thus, the training and/or analysis performed by machine learning architectures is not performed by predefined computer algorithms but rather improve the functioning of the computer system and extends well beyond mental processes and abstract ideas.

FIG. 1B illustrates an example process 50 of simulating fluid flow for a subsurface volume of interest that comprises at least one fracture. The process 50 utilizes a first diffusivity-based transmissibility modification method (referred to as Diff-based A method herein). A simple running example is discussed in the context of the process 50 for case of understanding.

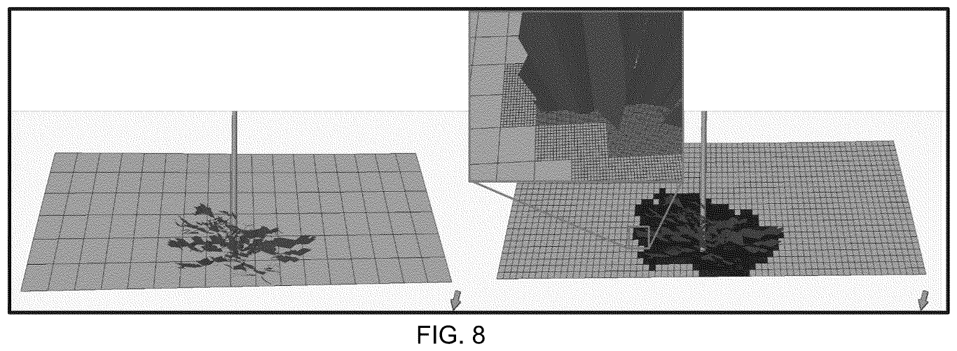

At step 55, the process 50 includes obtaining a reservoir model for a subsurface volume of interest that includes at least one fracture (e.g., a hydraulic fracture created via hydraulic fracturing or a natural fracture). The reservoir model is in coarse scale instead of fine scale. FIG. 8 illustrates a non-limiting example of coarse scale on the left and fine scale on the right. In a non-limiting example, a particular reservoir model can be at a coarse scale when it has a cell size in a range of 50-200 ft, whereas the same particular reservoir model can be at a fine scale when it has a cell size in a range of 0.1-25 ft. The cell size for coarse scale versus the cell size for fine scale may depend on the reservoir model, the desired simulation output, etc. The reservoir model includes information about the subsurface volume of interest and the at least one fracture. The reservoir model includes a plurality of matrix-fracture (MF) connections. Additionally, the reservoir model may include information regarding geometry, well definitions, subsurface properties, fluid, etc. The reservoir model will be input for the reservoir simulator to perform the simulation. The running example includes obtaining one reservoir model in coarse scale with three MF connections for a subsurface volume of interest that includes one hydraulic fracture.

At step 60, the process 50 includes performing a simulation and generating simulation output using the obtained reservoir model to solve for fluid flow of the subsurface volume of interest that comprises the at least one fracture. The simulation includes a plurality of time steps. The simulation may be performed using the reservoir simulator. The running example includes performing a simulation using the obtained reservoir model in coarse scale to solve for fluid flow of the subsurface volume of interest that includes the at least one hydraulic fracture.

For each time step of the simulation, the process 50 includes (i) obtaining simulation data for calculating a transmissibility for each matrix-fracture connection (step 65), (ii) calculating the transmissibility for each matrix-fracture connection using the obtained simulation data and a first diffusivity-based transmissibility modification method (step 70), (iii) modifying a previous transmissibility of each matrix-fracture connection in the reservoir model with the corresponding transmissibility calculated using the first diffusivity-based transmissibility modification method (step 75), and (iv) solving for fluid flow using the modified reservoir model (step 80). The running example assumes that the simulation includes ten-time steps.

Turning more specifically to the step 65, the process 50 includes (i) obtaining simulation data for calculating a transmissibility for each matrix-fracture (MF) connection. For example, the simulation data may include pressure data, permeability data, porosity data, etc. The simulation data that is obtained may depend on the first diffusivity-based transmissibility modification method. The reservoir simulator may be queried for the simulation data. The running example includes obtaining simulation data for calculating transmissibilities.

Turning more specifically to the step 70, the process 50 includes (ii) calculating the transmissibility for each matrix-fracture connection using the obtained simulation data and a first diffusivity-based transmissibility modification method. The transmissibility for each matrix-fracture connection that is calculated using the obtained simulation data and the first diffusivity-based transmissibility modification method changes over time, whereas transmissibility generally does not change over time in traditional approaches. The period of time may vary depending on the desired simulation output. For instance, if simulating 2 years, then over time will be up to 2 years. For instance, if simulating for 1 day, then over time is up to 1 day. The period of time may be provided via user input. The running example includes calculating three transmissibilities at each time step using the obtained simulation data and the first diffusivity-based transmissibility modification method because there are three MF connections in this running example.

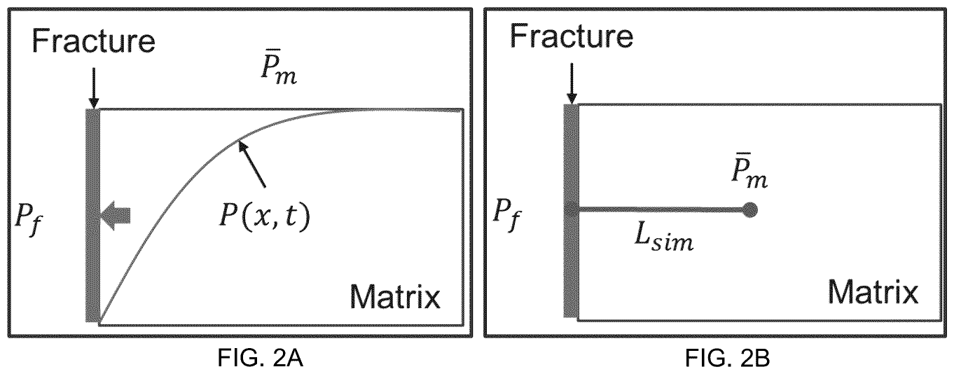

First diffusivity-based transmissibility modification method (Diff-based A method)—This method assumes that the pressure inside the matrix follows a one-dimensional transient diffusion as it is shown in FIG. 2A. The diffusion model assumes a single-phase fluid and the pressure far away from the fracture remains constant and equal to the initial matrix pressure (Pᵢ). The average pressure of a grid cell is denoted by P̅ₘ. It is assumed here that there is an infinitely long reservoir; this assumption is valid during the transient period given that the pressure change is localized close to the fracture and farther from the fracture pressure remains unaltered.

The dimensionless pressure (P_{D}) is given by

$${P}_{D} = \frac{P ( x , t ) - {P}_{i}}{{P}_{f} - {P}_{i}} \qquad ( 2 )$$

where P(x,t) is the pressure in the matrix at distance x and time t, and P_{f} is the pressure at the fracture.

The dimensionless pressure distribution within the matrix, assuming constant pressure at the fracture face and constant fluid properties, is expressed as follows

$${P}_{D} ( x , t ) = erfc ( \frac{x}{\sqrt{4 {α}_{h} t}} ) \qquad ( 3 )$$

with αₕ given by

$${α}_{h} = \frac{6.3248 \times 1 {0}^{- 3} {k}_{m}}{{C}_{t} ϕ μ} \qquad ( 4 )$$

where kₘ is the permeability of the matrix, Cₜ is the total compressibility, ϕ is the porosity, and μ is the viscosity of the fluid. From Equation 3, the change of dimensionless pressure can be computed with respect to x at the fracture face (x=0)

$${( \frac{\partial {P}_{D}}{\partial x} )}_{x = 0} = \frac{- 1}{\sqrt{π {α}_{h} t}} \qquad ( 5 )$$

To compute the flow rate at the fracture face, the Darcy equation can be utilized, and the derivative of pressure can be evaluated with respect to distance at the fracture face. Hence, the flow rate at the fracture face is given by

$${q \vert}_{x = 0} = - \frac{{k}_{m} {A}_{f} ( {P}_{f} - {P}_{i} )}{μ} {( \frac{\partial {P}_{D}}{\partial x} )}_{x = 0} \qquad ( 6 )$$

where A_{f} is the area of the fracture. The flow rate between a fracture cell and a matrix cell in reservoir simulation is computed using the average pressure of the matrix cell and the distance between the fracture and the matrix block (Lₛᵢₘ) as it is shown in FIG. 2B. The value of Lₛᵢₘ depends on the type of connection used between the fracture and the matrix, for example, it would be different for an explicit fracture to a connection using EDFM.

$${q}_{s i m} = - \frac{{k}_{m} {A}_{f} ( {P}_{f} - {\overline{P}}_{m} )}{μ {L}_{s i m}} \qquad ( 7 )$$

From Equations 6 and 7, the ratio of flow rate between the analytical solution and the simulation can be computed:

$${q}_{ratio} = \frac{{q \vert}_{x = 0}}{{q}_{sim}} = \vert \frac{{P}_{f} - {P}_{i}}{{P}_{f} - {\overline{P}}_{m}} \vert \frac{{L}_{sim}}{M \sqrt{π {α}_{h} t}} \qquad ( 8 )$$

In Equation 8, the absolute value of the pressure differences was used because of an interest in the magnitude rather than its sign and to avoid the calculation of a negative transmissibility. Lₛᵢₘ is distance between fracture block and middle of matrix block (e.g., FIG. 2B) and αₕ is diffusivity coefficient. Also, a calibration factor M was added to adjust the analytical response to the response from the simulation due to all the restricting assumptions in the analytical model.

The transmissibility for a matrix-fracture connection using EDFM is given by

$${T}_{EDFM} = \frac{{k}_{m} \cdot {A}_{f}}{{L}_{sim}} \qquad ( 9 )$$

with

$${L}_{sim} = \frac{\int {x}_{n} dv}{V} \qquad ( 10 )$$

where xₙ is the normal distance to the fracture and V the volume of the matrix cell.

Hence, the equivalent transmissibility for a matrix-fracture connection in reservoir simulation so that the connection flow rate is that of the analytical model is obtained by multiplying qᵣₐₜᵢₒ with the simulator computed transmissibility

$${T}_{Analytical} = {q}_{ratio} {T}_{EDFM} = \vert \frac{{P}_{f} - {P}_{i}}{{P}_{f} - {\overline{P}}_{m}} \vert \frac{{k}_{m} \cdot {A}_{f}}{M \sqrt{π {α}_{h} t}} \qquad ( 11 )$$

Using the transmissibility from Equation 11, the reservoir simulator can model the transient effects that occur during the initial time. However, the analytical model only considers the transient effects and does not model the pseudo-steady state (assumption that the flow from matrix to the fracture is characterized by the average pressure in the matrix and it is proportional to the difference in fracture and matrix pressure) of the late times. It is necessary to define a criterion as to when to use the analytical transmissibility. As such, qᵣₐₜᵢₒ can be used to indicate the transition between transient to pseudo-steady state and compute transmissibility during simulation as follows

$$T = \{ \begin{matrix}{T}_{Analytical} & if {q}_{ratio} > 1 \\ {T}_{EDFM} & if {q}_{ratio} \leq 1\end{matrix} \qquad ( 12 )$$

Thus, the Diff-based A method may use a one-dimensional, single phase transient diffusion model. The Diff-based A method may assume that the simulation time is the same as the time in the analytical model (e.g., one-dimensional, single phase transient diffusion model). The transmissibility value (Equation 12) may depend on the ratio of flow rate between the simulation and the one-dimensional, single phase transient diffusion model (Equation 8). This ratio is referred to as qᵣₐₜᵢₒ herein. At qᵣₐₜᵢₒ greater than one, the transmissibility may be computed from the one-dimensional, single phase transient diffusion model using simulation time as input (Equation 11). Otherwise, the transmissibility value used may be determined via Equation 9. A different value of qᵣₐₜᵢₒ is determined for each MF connection at that time step.

Turning more specifically to the step 75, the process 50 includes (iii) modifying a previous transmissibility of each matrix-fracture connection in the reservoir model with the corresponding transmissibility calculated using the first diffusivity-based transmissibility modification method. The transmissibilities that were modified in the previous timestep are modified again in the next timestep, and so on. The previous transmissibility of each matrix-fracture connection in the reservoir model in the first step (i.e., initial transmissibility of each matrix-fracture connection in the reservoir model in the first step) may be provided via user input, generated by the simulator, generated by a separate process, etc. The modification in transmissibilities of matrix-fracture connections is made directly in the reservoir model. The running example includes modifying the three previous transmissibilities for the three MF connections in the reservoir model with the corresponding three transmissibilities calculated using the first diffusivity-based transmissibility modification method at each time step because there are three MF connections in this running example.

Turning more specifically to the step 80, the process 50 includes (iv) solving for fluid flow using the modified reservoir model. Fluid flow may be solved using the modified transmissibilities in the modified reservoir model. The modified transmissibilities for the matrix-fracture connections may help capture transient effects during the simulation. Of note, fluid flow may be solved using unmodified transmissibilities in the modified reservoir model, such as unmodified transmissibilities of non-MF connections (e.g., matrix-matrix connections, fracture-fracture connections, anything connecting a well, etc.). The running example includes solving for fluid flow using the modified reservoir model at each time step.

After the time steps have been completed, the simulation output may include flow rates, production profiles, spatial reservoir properties (e.g., pressure, saturations, etc.), etc. with all of these being over time. The simulation output may include a hydrocarbon production prediction, a subsurface property prediction (e.g., pressure, fluid saturation, etc.), or any combination thereof. The simulation output may be used (step 85) for other computer workflows, perform analysis, decrease uncertainty, increase understanding of subsurface processes, influence business decisions, etc. Business decision may include DPI, infill drilling opportunities, production plateau period, secondary/tertiary hydrocarbon recovery operations, vertical/horizontal interference between wells, depletion estimation, etc.

FIG. 1C illustrates an example process 51 of simulating fluid flow for a subsurface volume of interest that comprises at least one fracture. The process 51 utilizes a second diffusivity-based transmissibility modification method (referred to as Diff-based B method herein). A simple running example is discussed in the context of the process 51 for case of understanding.

At step 55, the process 51 includes obtaining a reservoir model for a subsurface volume of interest that includes at least one fracture (e.g., at least one hydraulic fracture created via hydraulic fracturing). The reservoir model is in coarse scale instead of fine scale. FIG. 8 illustrates a non-limiting example of coarse scale on the left and fine scale on the right. In a non-limiting example, a particular reservoir model can be at a coarse scale when it has a cell size in a range of 50-200 ft, whereas the same particular reservoir model can be at a fine scale when it has a cell size in a range of 0.1-25 ft. The cell size for coarse scale versus the cell size for fine scale may depend on the reservoir model, the desired simulation output, etc. The reservoir model includes information about the subsurface volume of interest and the at least one fracture. The reservoir model includes a plurality of matrix-fracture (MF) connections. Additionally, the reservoir model may include information regarding geometry, well definitions, subsurface properties, fluid, etc. The reservoir model will be input for the reservoir simulator to perform the simulation. The running example includes obtaining one reservoir model in coarse scale with three MF connections for a subsurface volume of interest that includes one hydraulic fracture.

At step 60, the process 51 includes performing a simulation and generating simulation output using the obtained reservoir model to solve for fluid flow of the subsurface volume of interest that comprises the at least one fracture. The simulation includes a plurality of time steps. The simulation may be performed using the reservoir simulator. The running example includes performing a simulation using the obtained reservoir model in coarse scale to solve for fluid flow of the subsurface volume of interest that includes the at least one hydraulic fracture.

For each time step of the simulation, the process 51 includes (i) obtaining simulation data for calculating a transmissibility for each matrix-fracture connection (step 66), (ii) calculating the transmissibility for each matrix-fracture connection using the obtained simulation data and a second diffusivity-based transmissibility modification method (step 71), (iii) modifying a previous transmissibility of each matrix-fracture connection in the reservoir model with the corresponding transmissibility calculated using the second diffusivity-based transmissibility modification method (step 76), and (iv) solving for fluid flow using the modified reservoir model (step 80). The running example assumes that the simulation includes ten-time steps.

Turning more specifically to the step 66, the process 51 includes (i) obtaining simulation data for calculating a transmissibility for each matrix-fracture connection. For example, the simulation data may include pressure data, permeability data, porosity data, etc. The simulation data that is obtained may depend on the second diffusivity-based transmissibility modification method. The reservoir simulator may be queried for the simulation data. The running example includes obtaining simulation data for calculating transmissibilities.

Turning more specifically to the step 71, the process 51 includes (ii) calculating the transmissibility for each matrix-fracture connection using the obtained simulation data and a second diffusivity-based transmissibility modification method. The transmissibility for each matrix-fracture connection that is calculated using the obtained simulation data and the second diffusivity-based transmissibility modification method changes over time, whereas transmissibility generally does not change over time in traditional approaches. The period of time may vary depending on the desired simulation output. For instance, if simulating 2 years, then over time will be up to 2 years. For instance, if simulating for 1 day, then over time is up to 1 day. The period of time may be provided via user input. The running example includes calculating three transmissibilities at each time step using the obtained simulation data and the second diffusivity-based transmissibility modification method because there are three MF connections in this running example.

An approach independent of time-Second diffusivity-based transmissibility modification method (Diff-based B method)—An extension to the diffusion-based A method is to remove the explicit time that appears in the qᵣₐₜᵢₒ (Equation 8). This could expand the applicability of this model to processes that have abrupt changes in well conditions (e.g., abrupt pressure changes in fracture pressure). First, Equation 3 is integrated over the length of the grid cell (x=[0,Lₘ]) and αₕ expression for the dimensionless average pressure for the grid cell (P̅ₚₘ) is obtained:

$${\overline{P}}_{Dm} = \frac{{\overline{P}}_{m} - {P}_{i}}{{P}_{f} - {P}_{i}} = erfc ( \frac{{L}_{m}}{\sqrt{4 {α}_{h} t}} ) + \frac{\sqrt{4 {α}_{h} t} ( 1 - {e}^{- {( \frac{{L}_{m}}{\sqrt{4 {a}_{h} t}} )}^{2}} )}{{L}_{m} \sqrt{π}} \qquad ( 13 )$$

Lₘ is length of matrix block, erfc is complimentary error function, and αₕ is diffusivity coefficient.

Equation (13) can be used to compute the effective time that the analytical model would need to obtain a given average pressure in the grid cell P̅ₘ. The solution is obtained solving the Equation (13) for t and using P̅ₘ from the simulator. Hence, the flow rate ratio and the analytical transmissibility can be computed using the effective time (t_{eff}).

$${q}_{ratio} = \vert \frac{{P}_{f} - {P}_{i}}{{P}_{f} - {\overline{P}}_{m}} \vert \frac{{L}_{sim}}{M \sqrt{π {α}_{h} {t}_{eff}}} \qquad ( 14 )$$

$${T}_{Analytical} = \vert \frac{{P}_{f} - {P}_{i}}{{P}_{f} - {\overline{P}}_{m}} \vert \frac{{k}_{m} \cdot {A}_{f}}{M \sqrt{π {α}_{h} {t}_{eff}}} \qquad ( 15 )$$

Thus, the Diff-based B method may use a one-dimensional, single phase transient diffusion model. The Diff-based B method may assume that the average pressure in the matrix cell is the same as the average pressure in an analytical model (e.g., one-dimensional, single phase transient diffusion model) of the same size. With this assumption, it is possible to compute an effective time (by solving Equation 13). The transmissibility value (Equation 12) depends on the ratio of flow rate between the simulation and the one-dimensional, single phase transient diffusion model (Equation 14). This ratio is referred to as qᵣₐₜᵢₒ herein. At qᵣₐₜᵢₒ greater than one, the transmissibility may be computed from the one-dimensional, single phase transient diffusion model using the effective time as input (Equation 15). Otherwise, the transmissibility value used may be determined via Equation 9. A different value of qᵣₐₜᵢₒ is determined for each MF connection at that time step.

It is worth noting that this Diff-based B method is more computationally expensive than the Diff-based A method because it requires the solution of a non-linear equation for each connection at each time.

Turning more specifically to the step 76, the process 51 includes (iii) modifying a previous transmissibility of each matrix-fracture connection in the reservoir model with the corresponding transmissibility calculated using the second diffusivity-based transmissibility modification method. The transmissibilities that were modified in the previous timestep are modified again in the next timestep, and so on. The previous transmissibility of each matrix-fracture connection in the reservoir model in the first step (i.e., initial transmissibility of each matrix-fracture connection in the reservoir model in the first step) may be provided via user input, generated by the simulator, generated by a separate process, etc. The modification in transmissibilities of matrix-fracture connections is made directly in the reservoir model. The running example includes modifying the three previous transmissibilities for the three MF connections in the reservoir model with the corresponding three transmissibilities calculated using the second diffusivity-based transmissibility modification method at each time step because there are three MF connections in this running example.

Turning more specifically to the step 80, the process 51 includes (iv) solving for fluid flow using the modified reservoir model. Fluid flow may be solved using the modified transmissibilities in the modified reservoir model. The modified transmissibilities for the matrix-fracture connections may help capture transient effects during the simulation. Of note, fluid flow may be solved using unmodified transmissibilities in the modified reservoir model, such as unmodified transmissibilities of non-MF connections (e.g., matrix-matrix connections, fracture-fracture connections, anything connecting a well, etc.). The running example includes solving for fluid flow using the modified reservoir model at each time step.

After the time steps have been completed, the simulation output may include flow rates, production profiles, spatial reservoir properties (e.g., pressure, saturations, etc.), etc. with all of these being over time. The simulation output may include a hydrocarbon production prediction, a subsurface property prediction (e.g., pressure, fluid saturation, etc.), or any combination thereof. The simulation output may be used (step 85) for other computer workflows, perform analysis, decrease uncertainty, increase understanding of subsurface processes, influence business decisions, etc. Business decision may include DPI, infill drilling opportunities, production plateau period, secondary/tertiary hydrocarbon recovery operations, vertical/horizontal interference between wells, depletion estimation, etc.

FIG. 1D illustrates an example process 52 of simulating fluid flow for a subsurface volume of interest that comprises at least one fracture. The process 52 utilizes a machine learning (ML)-based transmissibility modification method (referred to as ML-based method herein). A simple running example is discussed in the context of the process 52 for case of understanding.

At step 55, the process 52 includes obtaining a reservoir model for a subsurface volume of interest that includes at least one fracture (e.g., at least one hydraulic fracture created via hydraulic fracturing). The reservoir model is in coarse scale instead of fine scale. FIG. 8 illustrates a non-limiting example of coarse scale on the left and fine scale on the right. In a non-limiting example, a particular reservoir model can be at a coarse scale when it has a cell size in a range of 50-200 ft, whereas the same particular reservoir model can be at a fine scale when it has a cell size in a range of 0.1-25 ft. The cell size for coarse scale versus the cell size for fine scale may depend on the reservoir model, the desired simulation output, etc. The reservoir model includes information about the subsurface volume of interest and the at least one fracture. The reservoir model includes a plurality of matrix-fracture (MF) connections. Additionally, the reservoir model may include information regarding geometry, well definitions, subsurface properties, fluid, etc. The reservoir model will be input for the reservoir simulator to perform the simulation. The running example includes obtaining one reservoir model in coarse scale with three MF connections for a subsurface volume of interest that includes one hydraulic fracture.

At step 60, the process 52 includes performing a simulation and generating simulation output using the obtained reservoir model to solve for fluid flow of the subsurface volume of interest that comprises the at least one fracture. The simulation includes a plurality of time steps. The simulation may be performed using the reservoir simulator. The running example includes performing a simulation using the obtained reservoir model in coarse scale to solve for fluid flow of the subsurface volume of interest that includes the at least one hydraulic fracture.

For each time step of the simulation, the process 52 includes (i) obtaining simulation data for calculating a transmissibility for each matrix-fracture connection (step 67), (ii) calculating the transmissibility for each matrix-fracture connection using the obtained simulation data and a ML-based transmissibility modification method (step 72), (iii) modifying a previous transmissibility of each matrix-fracture connection in the reservoir model with the corresponding transmissibility calculated using the ML-based transmissibility modification method (step 77), and (iv) solving for fluid flow using the modified reservoir model (step 80). The running example assumes that the simulation includes ten-time steps.

Turning more specifically to the step 67, the process 52 includes (i) obtaining simulation data for calculating a transmissibility for each matrix-fracture connection. For example, the simulation data may include pressure data, permeability data, porosity data, etc. The simulation data that is obtained may depend on the ML-based transmissibility modification method. The reservoir simulator may be queried for the simulation data. The running example includes obtaining simulation data for calculating transmissibilities.

Turning more specifically to the step 72, the process 52 includes (ii) calculating the transmissibility for each matrix-fracture connection using the obtained simulation data and a ML-based transmissibility modification method (referred to as ML-based method herein). The transmissibility for each matrix-fracture connection that is calculated using the obtained simulation data and the ML-based transmissibility modification method changes over time, whereas transmissibility generally does not change over time in traditional approaches. The period of time may vary depending on the desired simulation output. For instance, if simulating 2 years, then over time will be up to 2 years. For instance, if simulating for 1 day, then over time is up to 1 day. The period of time may be provided via user input. The running example includes calculating three transmissibilities at each time step using the obtained simulation data and the ML-based transmissibility modification method because there are three MF connections in this running example.

ML-based transmissibility modification method (ML-based method)—An alternative to the methods using an analytical solution to obtain the transmissibility modification during transient times is to use machine learning to compute the transient transmissibility. In this ML-based method, artificial neural networks (ANN) are used as a proxy for simulation. The ANNs offer more flexibility over an analytical solution because they can be trained to include more complex physics. The ANNs could encode the transient behavior observed in refined models and transfer it to the coarse model.

In this ML-based method, the ANN contains hidden fully connected layers (e.g., three hidden fully connected layers). Between the hidden layers, the rectified linear unit (ReLU) transfer function is used to add nonlinearity to the system. Sigmoid function is used as the transfer function for the output layer.

The ML-based method includes the training of an ANN to predict the flow rate of the fluids at the fracture face using information from refined models. The input parameters to the ANN are chosen such that they are independent of the grid resolution, hence they could be obtained from the coarse model allowing the use of this ANN from the coarse simulation. Here, the reservoir properties such as porosity and permeability are assumed to be constant in the coarse model. Separately, another ANN is trained to predict the transmissibility of the coarse model from fluid flow rate. The second ANN works as a reverse proxy between transmissibility and flow rate for the coarse model.

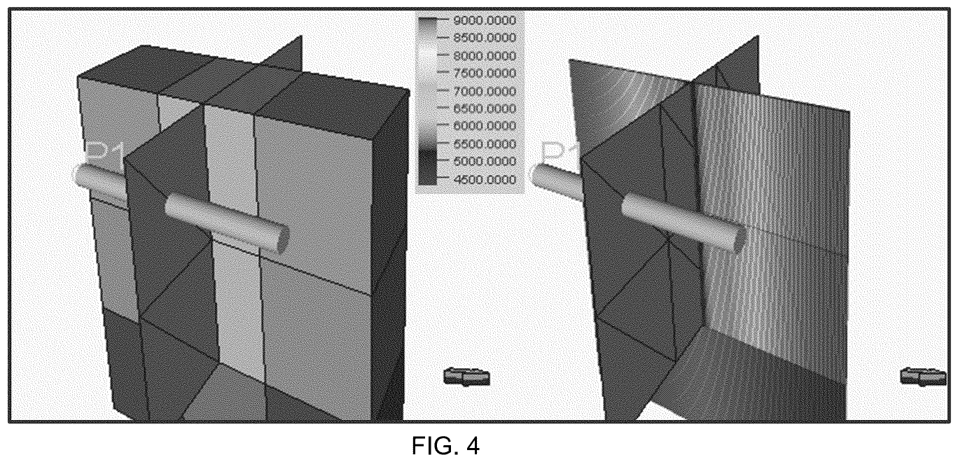

The ML-based method for estimation of transmissibility is shown in FIG. 4. At the beginning of any time step during the simulation, the input parameters are gathered from the current state of variables from the coarse model. This input is used in the ANN trained with the refined model to obtain an estimate on the oil and gas flow rate at the fracture face. Then, the same input used in the first ANN is utilized plus the estimation of flow rates and the difference in pressure between the matrix and fracture cells in the coarse model as the input to the second ANN (trained with coarse models) to estimate the transmissibility of the coarse model.

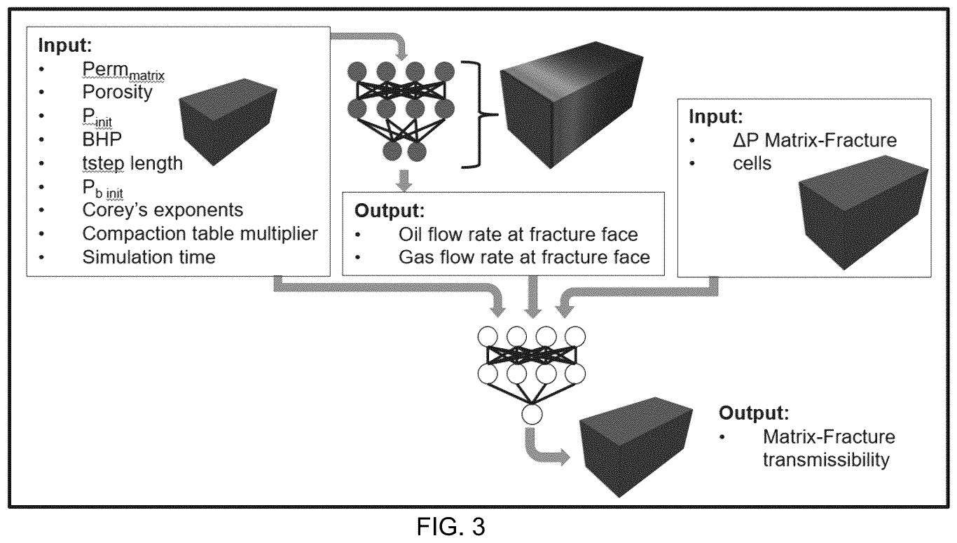

Thus, the ML-based method may use a plurality of ANNs working in tandem. The first ANN may be called to obtain the estimated flow rates at fracture face. Using the estimated flow rates at fracture face as additional input, the second ANN may be called, and the transmissibility of the connection is determined (FIG. 3).

Turning more specifically to the step 77, the process 52 includes (iii) modifying a previous transmissibility of each matrix-fracture connection in the reservoir model with the corresponding transmissibility calculated using the ML-based transmissibility modification method. The transmissibilities that were modified in the previous timestep are modified again in the next timestep, and so on. The previous transmissibility of each matrix-fracture connection in the reservoir model in the first step (i.e., initial transmissibility of each matrix-fracture connection in the reservoir model in the first step) may be provided via user input, generated by the simulator, generated by a separate process, etc. The modification in transmissibilities of matrix-fracture connections is made directly in the reservoir model. The running example includes modifying the three previous transmissibilities for the three MF connections in the reservoir model with the corresponding three transmissibilities calculated using the ML-based transmissibility modification method at each time step because there are three MF connections in this running example.

Turning more specifically to the step 80, the process 52 includes (iv) solving for fluid flow using the modified reservoir model. Fluid flow may be solved using the modified transmissibilities in the modified reservoir model. The modified transmissibilities for the matrix-fracture connections may help capture transient effects during the simulation. Of note, fluid flow may be solved using unmodified transmissibilities in the modified reservoir model, such as unmodified transmissibilities of non-MF connections (e.g., matrix-matrix connections, fracture-fracture connections, anything connecting a well, etc.). The running example includes solving for fluid flow using the modified reservoir model at each time step.

After the time steps have been completed, the simulation output may include flow rates, production profiles, spatial reservoir properties (e.g., pressure, saturations, etc.), etc. with all of these being over time. The simulation output may include a hydrocarbon production prediction, a subsurface property prediction (e.g., pressure, fluid saturation, etc.), or any combination thereof. The simulation output may be used (step 85) for other computer workflows, perform analysis, decrease uncertainty, increase understanding of subsurface processes, influence business decisions, etc. Business decision may include DPI, infill drilling opportunities, production plateau period, secondary/tertiary hydrocarbon recovery operations, vertical/horizontal interference between wells, depletion estimation, etc.

The strengths of the Diff-based A method, Diff-based B method, and ML-based method have been highlighted herein. Moreover, this disclosure provides three cases with different complexity showcasing the applicability of the three methods. The first is a planar EDFM model, followed by an EDFM model with complex fracture structure. In the last model, the ML-based method was shown in a 1D model with an explicit fracture. All simulations were performed using INTERSECT reservoir simulator.

Planar-Fracture EDFM—The first case uses a model with a planar fracture in the middle of the grid. There are three layers (66.6 ft each) and the fracture intersect the two upper layers. The matrix permeability and porosity are 1×10⁻⁵ md and 0.05, respectively. There is a horizontal well off-center of the model and produces at a constant BHP of 4000 psi. Flow into the well is only allowed through the fracture. Two grid resolutions were used in X and Y directions. The coarse model has three cells in X and Y and each cell has a size of 50 ft in both directions. The refined model has 150 cells in X and 151 cells in Y with a cell size of 1 ft in X and 0.993 ft in Y. The refined model was used as the reference case to compare the transient effects using the coarse model. The illustration of each model is shown in FIG. 4.

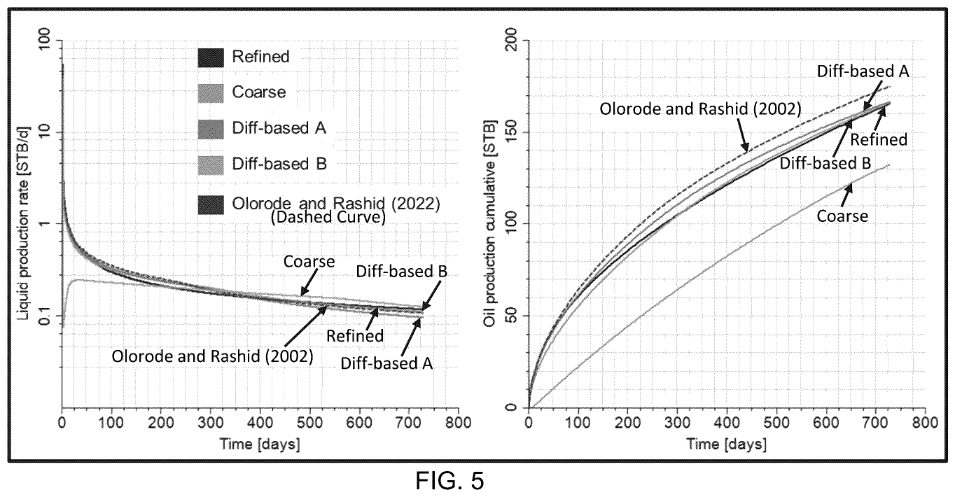

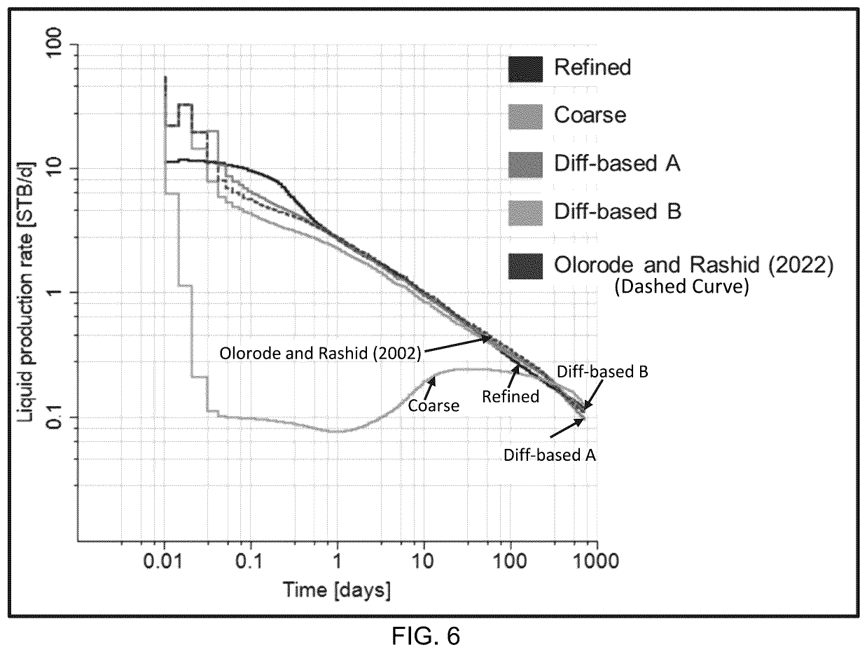

The results of the coarse model (solid gray curves) and refined model (solid black curves) were compared with each of the two diffusion-based analytical modification methods (curves with arrows and labels). For comparison purposes, the modifications of Olorode, O. and Rashid, H. 2022 (i.e., Olorode, O. and Rashid, H. 2022. Analytical modification of EDFM for transient flow in tight rocks. Sci Rep 12, 22018. https://doi.org/10.1038/s41598-022-26536-w, which is incorporated by reference) were also shown (dashed black curves). In all cases shown here, pressure was used instead of potentials to compute the transmissibility multiplier of Olorode and Rashid (2022). Liquid production rate and cumulative oil production are shown in FIG. 5 in the left and right, respectively. Liquid flow rate in log-log scale is shown in FIG. 6.

From the refined model, one can observe there are strong transient effects in the first 250 days of simulation, followed by a transition period where the transient effects are decreasing in importance. The coarse model is unable to account for these effects. The coarse model under predicts the flow rate at early times, and overpredicts flow rates at the end of simulation. The cumulative oil computed from the coarse model is lower for all the time simulated.

When the diff-based A transmissibility modification was used, one can improve the results from the coarse model. Here, the calibration factor (M) was modified to get a result close to the refined model for the liquid flow rate and the cumulative oil production. When using the diff-based B transmissibility modification, very good results were obtained without modification of the calibration factor, and a better representation of the oil production cumulative was obtained than the diff-based A. The Olorode and Rashid (2022) modification provides good estimates overall, however, it overestimates the cumulative oil production.

All models tested can give good results in the transient-flow dominated part of the simulation and are good in the transition time. The model tested in this case is close to the geometrical assumptions used in the diffusion-based approaches and as expected, good results were obtained.

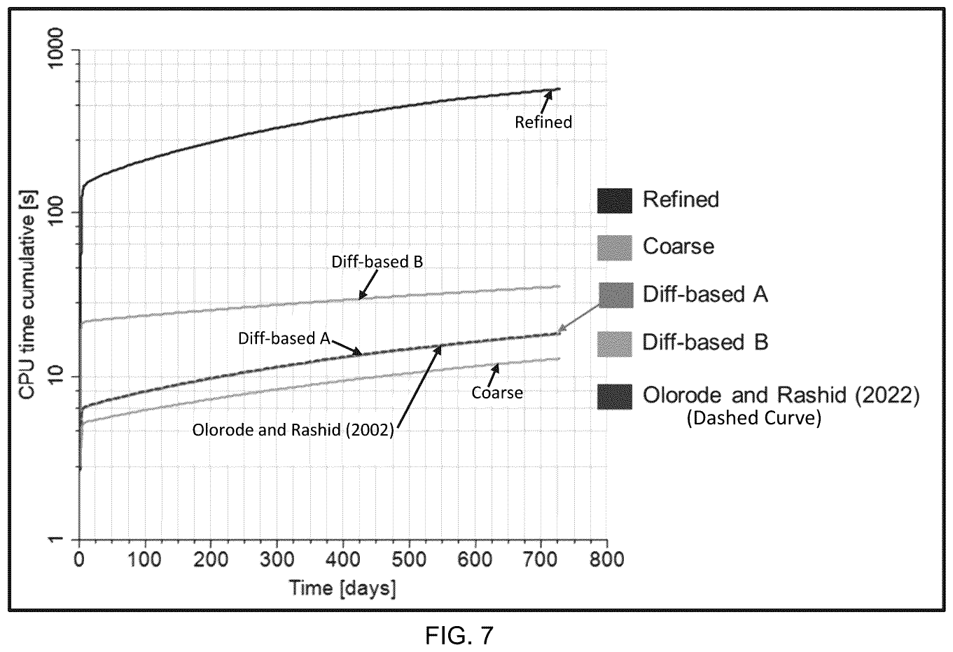

FIG. 7 shows the elapsed CPU time for each of the simulations evaluated. There are more than two orders of magnitude between the refined and the coarse models. The addition of transmissibility modification does not significatively increases the CPU time. The need to solve for effective time in the diff-based B approach for each connection creates the additional overhead observed in the FIG. 7.

Complex EDFM—For this case, a complex fracture model using EDFM was used. The fracture is based on a single stage hydraulic fracturing model based on the hydraulic fracturing test site 1 (HFTS1) (Reeves, S., Ciczobka J. and Perry K. 2020. Test Site Advances Hydraulic Fracturing in the Permian Basin. Oil & Gas Journal, 118 (7), which is incorporated by reference). The complexity of the hydraulic fracture can be observed in FIG. 8. Two grids were studied. A coarse grid, with cell size of 200 ft in X and Y was studied. The left grid in FIG. 8 shows the coarse grid, and it can be observed that a single coarse grid cell is in contact with multiple fracture segments. The coarse grid contains more than 19 thousand MF connections. The second grid studied, used for reference, is a refined grid with cell size of 50 ft with two levels of local grid refinements around the fractures, the size of the innermost Local Grid Refinement (LGR), the cells in contact with the fractures, is 2 ft. A horizontal well intercept the fractures and produces at a constant bottom hole pressure.

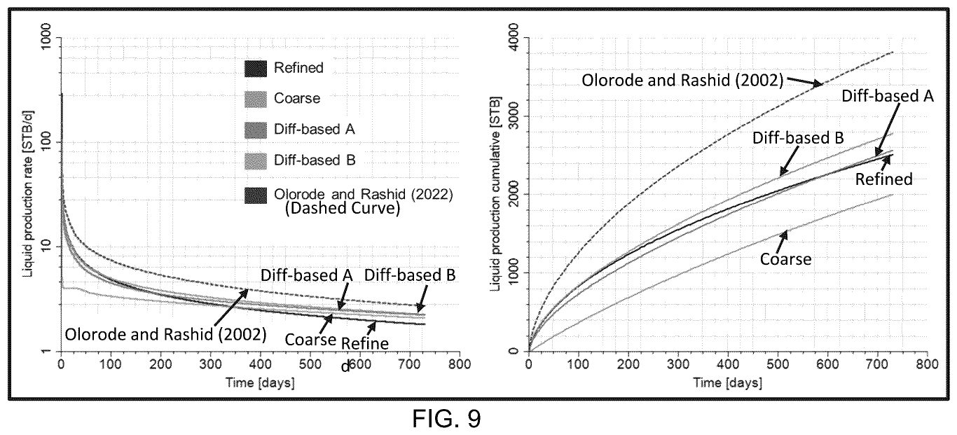

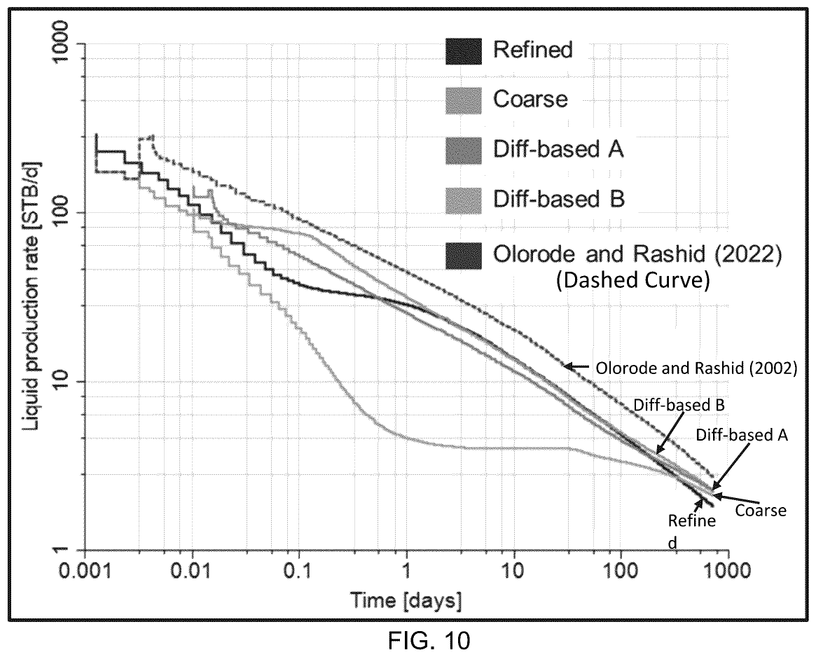

The liquid production rate and the cumulative liquid production are shown in FIG. 9. FIG. 10 shows the liquid production rate in log-log scale. One can observe that the unmodified coarse model does not capture the production profile of the refined model. The coarse model underpredicts at early times and overpredicts at late times for the production rate and underpredicts the cumulative liquid produced. Using any of the analytical modifications presented herein improves the prediction on both the production rate and the cumulative production. This complex EDFM case requires the modification of the calibration factor (M) for both diffusion-based models because the geometry of the MF connections is very different from the assumption used in the derivation of the analytical models. However, the use of the calibration factor makes possible to obtain a very close response to the refined model. If the interest is to obtain very good results during the transient period (early times), then a calibration factor can be applied that produces accurate results on the early times, however, the response at later times will be less accurate as one can see in the results using the diff-based B approach. On the other hand, if one prefers good match over the simulated interval, then a calibration factor should be chosen such that the overall solution is close to the refined model as shown with the solution from the diff-based A approach. When using the approach of Olorode and Rashid (2022), one can observe that although the production and cumulative trends are captured, this approach overestimates the liquid production rate over all times simulated.

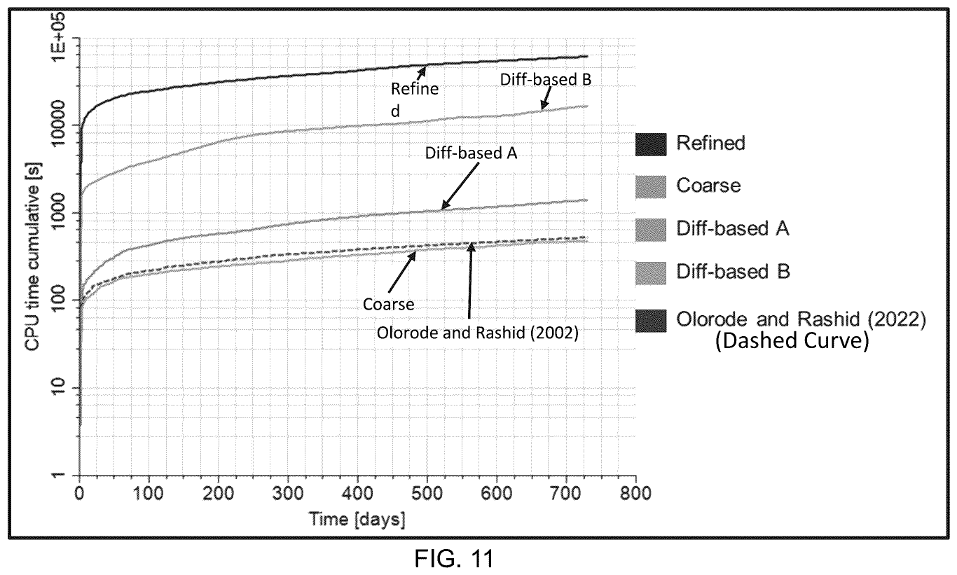

The elapsed CPU time is shown in FIG. 11. In this case, the Diff-based B approach incurs in overhead due to the solution of the effective time for each MF connection making it approximately 3.7 times faster than the refined model.

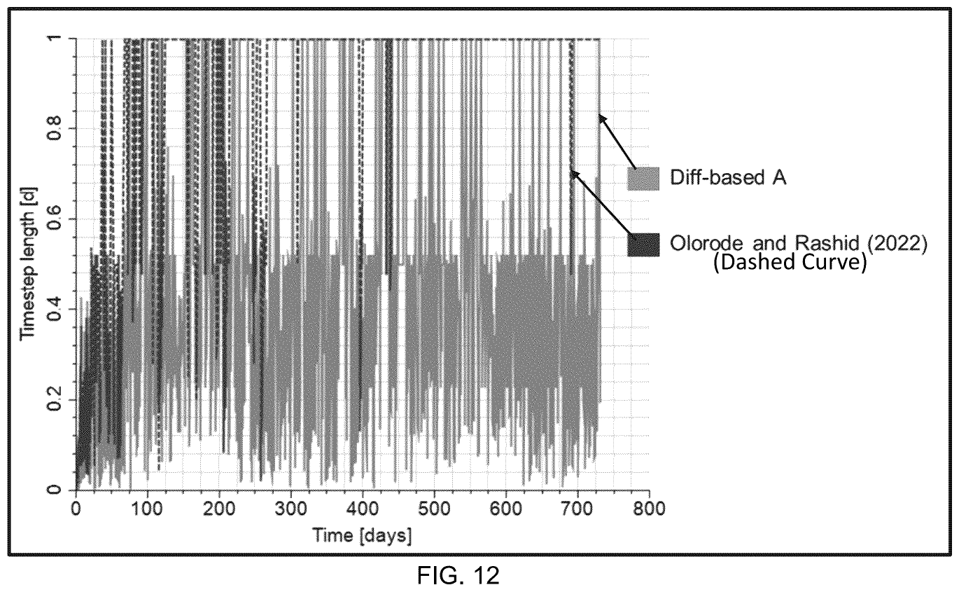

On the contrary, the Diff-based A approach is 43.9 times faster than the refined model and it does produce very similar results. An increase in CPU time using Diff-based A was observed compared to the coarse model and the modification of Olorode and Rashid (2022). The changes in transmissibility obtained from the Diff-based B approach make the non-linear system of the simulation harder to solve and requires smaller time step size, effectively increasing CPU time as it is observed in FIG. 12.

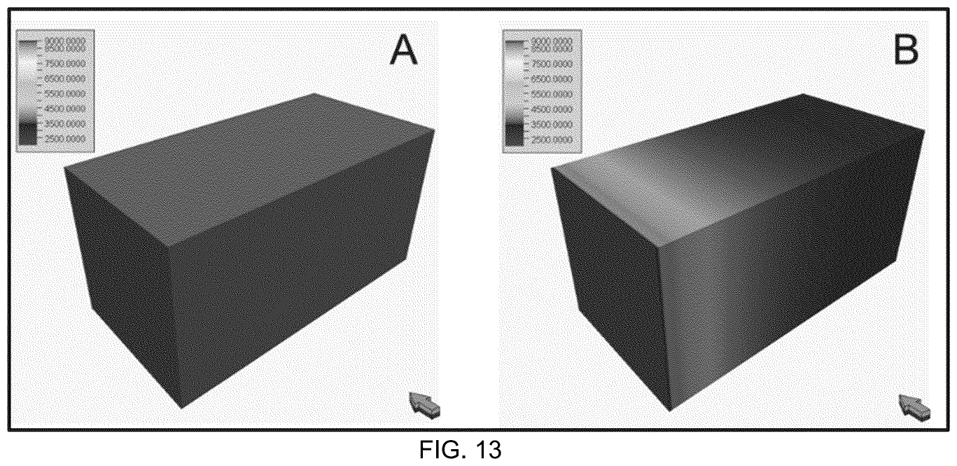

1D Explicit Fracture case—In this case, the capabilities of the ML-based transmissibility modification were tested. A one-dimensional case with an explicit fracture modeled was used. The coarse model has one fracture cell and one matrix cell. The refined model has one fracture cell and 500 matrix cells as it is shown in FIG. 13. Fluids are produced from a well connected to the fracture cell at a constant bottom hole pressure.

As it was described previously, the ML-based approach uses two ANN. The first ANN is trained on the refined model. The ANN contains three fully connected hidden layers with 32, 64 and 32 neurons each, respectively. The input ranges shown in Table 1 were used. Two thousand refined simulation cases were created using Latin hyper-cube sampling for training and validation. The ANN used Adam optimizer during training. The outputs for this ANN are the oil and gas flow rates. To correctly incorporate the flow rate at early times, a logarithmic sampling through time was needed because the flow rate changes rapidly at early times.

TABLE 1
Input parameters and their ranges used
to train the refined-model ANN.

| Input | Range |
|---|---|
| Permₘₐₜᵣᵢₓ (matrix permeability) (mD) (from | 4 × 10⁻⁶-4 × 10⁻⁴ |
| the reservoir model in coarse scale) | |
| Porosity (from the reservoir model in coarse | 0.01-0.3 |
| scale) | |
| Pᵢₙᵢₜ (initial reservoir pressure) (psi) (from | 7500-9500 |
| the reservoir model in coarse scale) | |
| Bottom Hole Pressure (BHP) (psi) (from the | 1500-3000 |
| reservoir model in coarse scale) | |
| P_{b init} (initial bubble point pressure) (psi) | 6000-7000 |
| (from the reservoir model in coarse scale) | |
| Corey's exponents (from the reservoir | 1-3 |
| model in coarse scale) | |
| Compaction table multiplier (from the | 0.02-0.8 |
| reservoir model in coarse scale) | |
| Simulation time (days) (from the reservoir | 0.01-730 |
| model in coarse scale) | |
| Tstep length (time step length) (days) (from | 0.01-1 |
| the reservoir model in coarse scale) | |

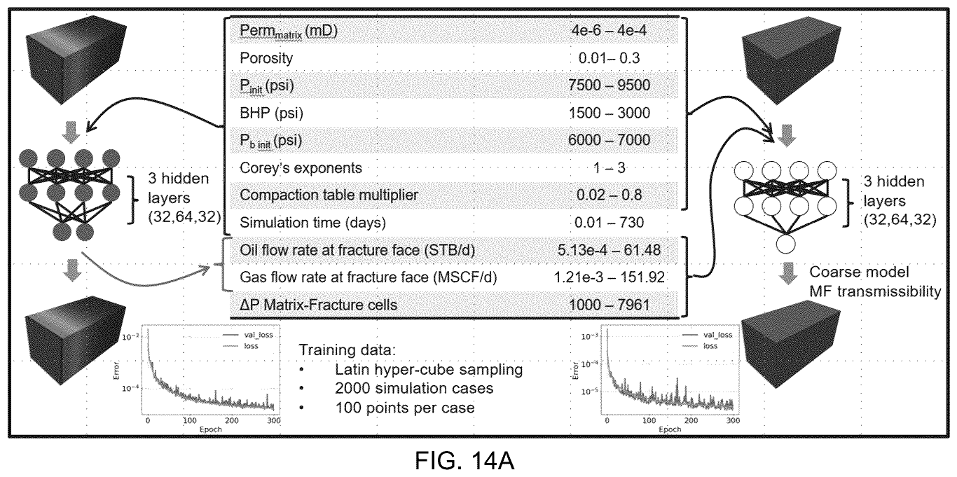

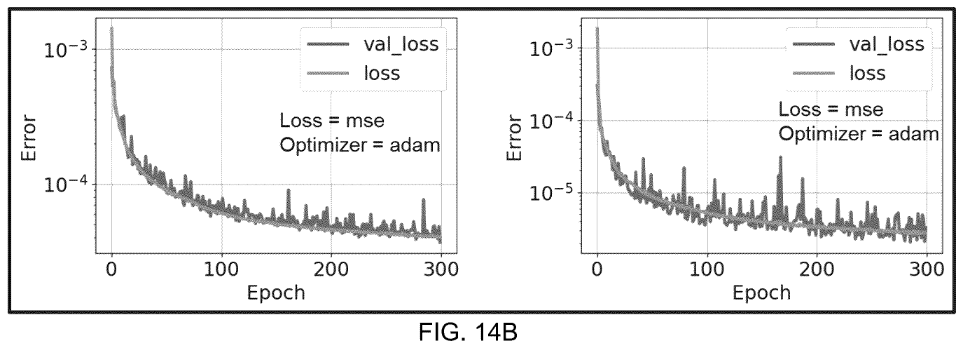

The second ANN uses the coarse model and acts as a reverse proxy between flow rate and transmissibility. The second ANN has a similar internal structure as the first ANN with three hidden layers (32, 64, 32 neurons each). Specifically, 2000 coarse simulation cases were generated to train and validate the second ANN. Each simulation case has a defined value of transmissibility, and the flow rate is evaluated as the result of the simulation at different conditions of pressure. This data is later rearranged before feeding it to the ANN, where the flow rate is used as input and the transmissibility is used as output. The input parameters are the same as the first ANN (Table 1) and additionally the ones shown in Table 2. While creating the training cases for the second ANN is important to sample the transmissibility values logarithmically because the transmissibility range spans several orders of magnitude. FIG. 14A illustrates a diagram of a 1D Explicit Fracture case with a ML-based transmissibility estimation workflow using two ANNs. FIG. 14B shows the error while training each ANN.

TABLE 2
Additional input parameters and their ranges
used to train the coarse-model ANN.

| Input | Range |
|---|---|
| ΔP Matrix-Fracture cells (difference in | 1000-7961 |
| pressure between matrix and fracture cells) | |
| (psi) (from the reservoir model in coarse | |
| scale) | |
| Oil flow rate at fracture face (STB/d) (from | 5.13 × 10⁻⁴-61.48 |
| the first ANN) | |
| Gas flow rate at fracture face (MSCF/d) | 1.21 × 10⁻³-151.92 |
| (from the first ANN) | |

Of note, logarithmic sampling is a sampling method that divides the sampling range equally in a logarithmic space, in this application, log base 10 was used, but it is not restricted to it. The idea is to provide a better sampling to train the ANN when the sampling ranges are several orders of magnitude apart. For example, if the sampling range is 1.0e-5 to 100, ten samples would be as follows: Linear sampling: 1.0e-5, 11.11, 22.22, 33.33, 44.44, 55.55, 66.66, 77.77, 88.88, 100 vs Logarithmic sampling: 1.0e-5, 5.994e-5, 3.594e-4, 2.154e-3, 1.291e-2, 7.742e-2, 4.642e-1, 2.783, 16.68, 100.

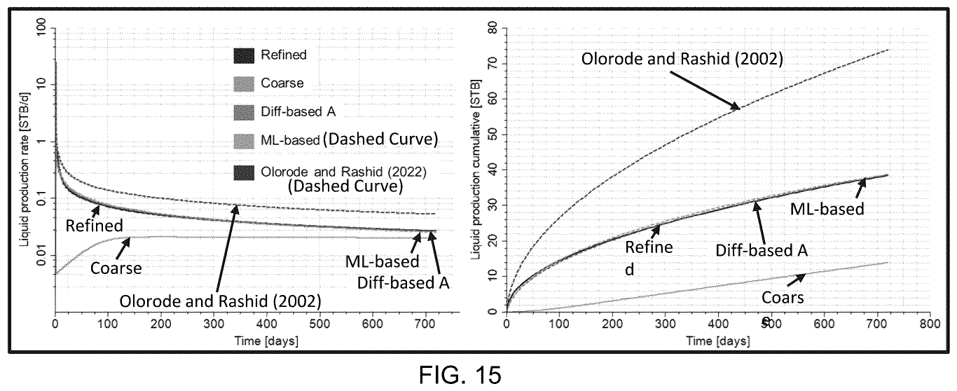

FIG. 15 illustrates a comparison of the results from the refined model, the coarse model, the coarse model with the Olorode and Rashid (2022) modification (dashed black curves), the Diff-based A modification (curves with arrows and labels), and the ML-based modification (curves with arrows and labels). One can observe the ML-based model results in good agreement with the refined and Diff-based A results, and this provides good confidence that the ML-based approach is a viable option to capture transient effects.

Next, the study proceeded to modify the refined case to include a behavior that it is difficult to include in the coarse model. Close to the fracture, the compaction table will be defined as

$$( 16 )$$

$$TM ( p ) = \{ \begin{matrix}{TM}_{max} & if p \geq p @ {TM}_{max} \\ ( {TM}_{min} - {TM}_{max} ) ( \frac{1 - {e}^{a ( p - p @ {TM}_{max} )}}{1 - {e}^{a ( {p}_{min} - p @ {TM}_{max} )}} ) + {TM}_{max} & if p < p @ {TM}_{max}\end{matrix}$$

where, TM is the transmissibility multiplier at pressure p, TMₘᵢₙ and TMₘₐₓ are the minimum and maximum transmissibility multiplier, a is the curvature parameter, and p@TMₘₐₓ is the pressure at the maximum transmissibility multiplier. The input parameters were augmented for both ANN by three and used the ranges shown in Table 3. The input in Table 3 may come from the reservoir model in coarse scale. Table 3 is from the compaction close to the fracture; it is only an example to show the flexibility of the ML-based method. These transmissibilities related to Table 3 should not be confused with the MF transmissibilities

TABLE 3
Additional input parameters for compaction table.

| Input (from reservoir model in coarse scale) | Range |
|---|---|
| TMₘᵢₙ (minimum transmissibility multiplier) | 0.03-0.3 |
| (from the reservoir model in coarse scale) | |
| p@TMₘₐₓ (pressure at max value of | 8500-9500 |
| transmissibility multiplier) (psi) (from the | |
| reservoir model in coarse scale) | |
| a (curvature) (from reservoir model in | 0.001-0.01 |
| coarse scale) | |

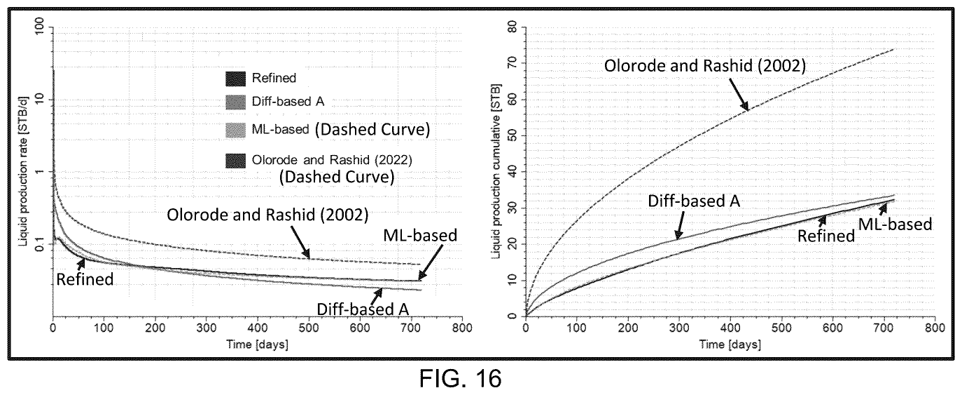

The results of the updated models are shown in FIG. 16. The ML-based model can capture the effect of the different compaction near the fracture and the flow rate, and the cumulative production are very close to the refined models. The Diff-based A approach is unable to account for the additional physics.

In summary, three different methods to include transient effect into coarse simulation models for unconventional reservoirs were provide herein.

Two of the methods are based on a single-phase diffusivity analytical solution. They provide a way to compute a direct value for transmissibility at early times that is independent on the value of transmissibility of late times. The Diff-based A approach provides a simple way to incorporate transient effects into coarse simulation models. It provides a criterion to transition to pseudo-steady state behavior and the proposed calibration factor makes it flexible to adapt to different simulation cases. The Diff-based B approach can produce accurate results and does not require time as an explicit input. Further improvements to computational efficiency in solving the effective time for MF connections or the use of proxies to perform this calculation could enable its use in complex and large models.

Using analytical-based approaches can efficiently model transient effects in unconventional reservoir simulation models, however, the transition period between transient and pseudo-steady state requires further investigation to be able to model it efficiently with analytical-based approaches. A workaround is to find a compromise in accuracy in both transient times and transition times that in average provides a good result.

The ML-based approach has the potential to capture not only transient times but also the transition period between transient and pseudo-steady state behaviors. Additionally, the ML-based approach can incorporate more physics than the analytical-based approaches and can be extended to fit each application.

The methods discussed herein could be extended to geothermal applications, where transient effects also occur in the heat transfer between the fracture and the hot rock. The methods discussed herein could also be extended to dual porosity, dual permeability (DPDK) models. More information may be found in the following: Barrios-Molano, Hector E., Rey, Alvaro, and Shihao Wang. “Analytical and Machine Learning Based Modifications to Unconventional Reservoir Simulation Models to Capture Near-Fracture Transient Effects.” Paper presented at the SPE/AAPG/SEG Unconventional Resources Technology Conference, Houston, Texas, USA, June 2024. doi: https://doi.org/10.15530/urtec-2024-4044074, which is incorporated by reference.

The present invention relates to a system that incorporates novel machine learning architectures for simulating fluid flow for a subsurface volume of interest that comprises at least one fracture. These architectures, which surpass human mental processes, operate beyond predefined algorithms and adapt dynamically to input data. In particular, the system leverages neural networks to achieve unprecedented performance.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

As used herein, the use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

As used herein, “obtaining” data or information may include one or more of accessing, acquiring, analyzing, determining, examining, identifying, loading, locating, opening, receiving, retrieving, reviewing, selecting, storing, and/or otherwise obtaining the data or information.

As used herein, regarding the term “pseudo-steady state”, there is an assumption that the flow from matrix to the fracture is characterized by the average pressure in the matrix and it is proportional to the difference in fracture and matrix pressure. This is usually observed at late times of production. More information is about the pseudo-steady state assumption (sometimes referred to as a quasi-steady state assumption) is available in John A. Barker, Block-geometry functions characterizing transport in densely fissured media, Journal of Hydrology, Volume 77, Issues 1-4, 1985, which is incorporated by reference.

As used herein, regarding the term “transient effects”, at early times of production, the flow from matrix to fracture is dependent on the pressure on the region close to the fracture and this region is changing over time. At these conditions, the pseudo-steady state assumption is wrong.

As used herein, regarding the “transition period between transient and pseudo-steady state”, this is the period of production time in which the flow regime changes from transient to pseudo-steady state. In this period, a smooth transition is observed between transient and pseudo-steady state.

As used herein, a “well” or a “wellbore” refers to a single hole, usually cylindrical when viewed in at least piecewise increments, that is drilled into a reservoir. A well may be drilled in one or more directions. For example, a well may include a vertical well or section of the well, a horizontal well or section of the well, a deviated well or section of the well, and/or other type of well or section of the well. A well may be drilled in the reservoir for exploration and/or recovery of resources. A plurality of wells (e.g., tens to hundreds of wells) or a plurality of well are often used in a field depending on the desired outcome.

A well may be drilled into a reservoir using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the reservoir, the hydrocarbons and/or other subsurface resources being produced, and/or other factors.

A well may include a plurality of components, including but not limited to a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well (e.g., injecting fluid for waterflooding, injecting fluid for hydraulic fracturing, etc.), control fluid flow out of the well, or any combination thereof. For example, a well may include a wellhead, a choke, a valve, and/or other control devices. These control devices may be located on the surface, in the subsurface (e.g., downhole in the well), or any combination thereof.

In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

As used herein, “hydraulic fracturing” is one way that hydrocarbons may be recovered (sometimes referred to as produced) from a reservoir in an economic manner. For example, hydraulic fracturing may entail preparing a fracturing fluid and injecting that fracturing fluid into the well at a sufficient rate and pressure to open existing fractures and/or create fractures in the reservoir. The fractures permit hydrocarbons to flow more freely into the well. In the hydraulic fracturing process, the fracturing fluid may be prepared on-site to include at least proppants. The proppants, such as sand or other particles, are meant to hold the fractures open so that hydrocarbons may more easily flow to the well. The fracturing fluid and the proppants may be blended together using at least one blender. The fracturing fluid may also include other components in addition to the proppants.

The well and the reservoir proximate to the well are in fluid communication (e.g., via perforations), and the fracturing fluid with the proppants is injected into the well through a wellhead of the well using at least one pump (oftentimes called a fracturing pump). The fracturing fluid with the proppants is injected at a sufficient rate and pressure to open existing fractures and/or create fractures in the reservoir. As fractures become sufficiently wide to allow proppants to flow into those fractures, proppants in the fracturing fluid are deposited in those fractures during the injection of the fracturing fluid. After the hydraulic fracturing process is completed, the fracturing fluid is removed by flowing or pumping it back out of the well so that the fracturing fluid does not block the flow of hydrocarbons to the well. The hydrocarbons may enter the same well from the reservoir and go up to the surface for further processing.

The equipment to be used in preparing and injecting the fracturing fluid may be dependent on the components of the fracturing fluid, the proppants, the well, the reservoir, etc. However, for simplicity, the term “fracturing apparatus” is meant to represent any tank(s), mixer(s), blender(s), pump(s), manifold(s), line(s), valve(s), fluid(s), fracturing fluid component(s), proppants, and other equipment and non-equipment items related to preparing the fracturing fluid and injecting the fracturing fluid.

As used herein, the term “hydrocarbon” refers to a compound containing carbon and hydrogen atoms. Hydrocarbons may include liquid hydrocarbons (also known as oil or petroleum), gas hydrocarbons, a combination of liquid hydrocarbons and gas hydrocarbons (e.g., including gas condensate), etc. For simplicity, many examples in this disclosure relate to the production of hydrocarbons. However, this disclosure applies to other produced fluid (e.g., produced water from a well, produced water from multiple wells, etc.), such as produced fluid in a liquid phase, produced fluid in a gas phase, or produced fluid in a combination of liquid phase and gas phase.

As used herein, a “reservoir” refers to a subsurface rock matrix in which a wellbore may be drilled. For example, a reservoir refers to a body of rock that is sufficiently distinctive and continuous such that it can be mapped. A reservoir stores resources, such as hydrocarbons, in its pore space. Reservoirs may vary in geologic features, such as, but not limited to, porosity, mineralogy, geomechanics, permeability, fluid saturation, presence of fractures, geologic structure (e.g., folds, manipulated by tectonic processes), thermal maturity, diagenetic alterations, etc. As used herein, in some embodiments, a reservoir may have a permeability of nanodarcy permeability to millidarcy permeability. The term reservoir may sometimes be used synonymously with the term “subsurface reservoir” or “subsurface formation” or “subsurface formation” or “subsurface volume of interest” or “subterranean formation” or “subsurface” or “formation” or the like. Indeed, the terms “hydrocarbon”, “reservoir”, and the like are not limited to any description or configuration described herein.

As used herein, an “unconventional reservoir” or “unconventional formation” generally requires intervention in order to recover hydrocarbons at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD). The permeability of a particular formation can be determined by averaging measured permeability values from a series of representative core samples obtained from the formation. The formation may also be divided up into one or more hydrocarbon zones, and hydrocarbons can be produced from each desired hydrocarbon zone.

As used herein, a “conventional formation” may have a permeability higher than that of an “unconventional formation.” The permeability of a particular formation can be determined by averaging measured permeability values from a series of representative core samples obtained from the formation.

As used herein, it is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of simulating fluid flow for a subsurface volume of interest that comprises at least one fracture, the method comprising:
a) obtaining a reservoir model for a subsurface volume of interest that comprises at least one fracture, wherein the reservoir model is in coarse scale, and wherein the reservoir model comprises a plurality of matrix-fracture connections; and
b) performing a simulation and generating simulation output using the obtained reservoir model to solve for fluid flow of the subsurface volume of interest that comprises the at least one fracture, wherein the simulation includes a plurality of time steps, and wherein for each time step of the simulation:
(i) obtaining simulation data for calculating a transmissibility for each matrix-fracture connection,
(ii) calculating the transmissibility for each matrix-fracture connection using the obtained simulation data and a first diffusivity-based transmissibility modification method, wherein the calculated transmissibility for each matrix-fracture connection changes over simulation time,
(iii) modifying a previous transmissibility of each matrix-fracture connection in the reservoir model with the corresponding transmissibility calculated using the first diffusivity-based transmissibility modification method, and
(iv) solving for fluid flow using the modified reservoir model.

2. The method of claim 1, wherein the first diffusivity-based transmissibility modification method uses a one-dimensional, single phase transient diffusion model.

3. The method of claim 2, wherein the first diffusivity-based transmissibility modification method uses a ratio of flow rate between the simulation data and the one-dimensional, single phase transient diffusion model to calculate a particular transmissibility value for a particular matrix-fracture connection, and wherein the ratio comprises simulation time.

4. The method of claim 3, wherein the ratio is calculated using an equation for qᵣₐₜᵢₒ, and wherein the qᵣₐₜᵢₒ equation comprises:
$${q}_{ratio} = \frac{{q \vert}_{x = 0}}{{q}_{sim}} = \vert \frac{{P}_{f} - {P}_{i}}{{P}_{f} - {\overline{P}}_{m}} \vert \frac{{L}_{sim}}{M \sqrt{π {α}_{h} t}}$$
wherein
$${q \vert}_{x = 0} = - \frac{{k}_{m} {A}_{f} ( {P}_{f} - {P}_{i} )}{μ} {( \frac{\partial {P}_{D}}{\partial x} )}_{x = 0}$$
wherein
$${q}_{s i m} = - \frac{{k}_{m} {A}_{f} ( {P}_{f} - {\overline{P}}_{m} )}{μ {L}_{s i m}}$$
wherein P_{f} is pressure at fracture, Pᵢ is initial matrix pressure, P̅ₘ is average pressure of a grid cell, P_{D} is dimensionless pressure, μ is viscosity of fluid, A_{f} is the area of the fracture, M is a calibration factor, x is distance, t is simulation time, kₘ is permeability of matrix, Lₛᵢₘ is distance between fracture block and middle of matrix block, and αₕ is diffusivity coefficient.

5. The method of claim 3, wherein the first diffusivity-based transmissibility modification method uses the one-dimensional, single phase transient diffusion model with the simulation time as input to calculate a particular transmissibility value for a particular matrix-fracture connection in response to the ratio.

6. The method of claim 3, wherein the first diffusivity-based transmissibility modification method uses Embedded Discreet Fracture Modeling to calculate a particular transmissibility value for a particular matrix-fracture connection in response to the ratio.

7. A method of simulating fluid flow for a subsurface volume of interest that comprises at least one fracture, the method comprising:
a) obtaining a reservoir model for a subsurface volume of interest that comprises at least one fracture, wherein the reservoir model is in coarse scale, and wherein the reservoir model comprises a plurality of matrix-fracture connections; and
b) performing a simulation and generating simulation output using the obtained reservoir model to solve for fluid flow of the subsurface volume of interest that comprises the at least one fracture, wherein the simulation includes a plurality of time steps, and wherein for each time step of the simulation:
(i) obtaining simulation data for calculating a transmissibility for each matrix-fracture connection,
(ii) calculating the transmissibility for each matrix-fracture connection using the obtained simulation data and a second diffusivity-based transmissibility modification method, wherein the calculated transmissibility for each matrix-fracture connection changes over simulation time,
(iii) modifying a previous transmissibility of each matrix-fracture connection in the reservoir model with the corresponding transmissibility calculated using the second diffusivity-based transmissibility modification method, and
(iv) solving for fluid flow using the modified reservoir model.

8. The method of claim 7, wherein the second diffusivity-based transmissibility modification method uses a one-dimensional, single phase transient diffusion model.

9. The method of claim 8, wherein the second diffusivity-based transmissibility modification method uses a ratio of flow rate between the simulation data and the one-dimensional, single phase transient diffusion model to calculate a particular transmissibility value for a particular matrix-fracture connection, and wherein the ratio comprises effective simulation time.

10. The method of claim 9, wherein the effective simulation time is calculated using dimensionless average pressure.

11. The method of claim 9, wherein the ratio is calculated using an equation with the effective simulation time for qᵣₐₜᵢₒ, and wherein the equation with the effective simulation time for qᵣₐₜᵢₒ comprises:
$${q}_{ratio} = \vert \frac{{P}_{f} - {P}_{i}}{{P}_{f} - {\overline{P}}_{m}} \vert \frac{{L}_{sim}}{M \sqrt{π {α}_{h} {t}_{eff}}}$$
wherein
$${q \vert}_{x = 0} = - \frac{{k}_{m} {A}_{f} ( {P}_{f} - {P}_{i} )}{μ} {( \frac{\partial {P}_{D}}{\partial x} )}_{x = 0}$$
wherein
$${q}_{s i m} = - \frac{{k}_{m} {A}_{f} ( {P}_{f} - {\overline{P}}_{m} )}{μ {L}_{s i m}}$$
wherein P_{f} is pressure at fracture, Pᵢ is initial matrix pressure, P̅ₘ is average pressure of a grid cell, P_{D} is dimensionless pressure, μ is viscosity of fluid, A_{f} is the area of the fracture, M is a calibration factor, x is distance, t_{eff} is effective simulation time, kₘ is permeability of matrix, Lₛᵢₘ is distance between fracture block and middle of matrix block, and αₕ is diffusivity coefficient.

12. The method of claim 11, wherein the effective simulation time is calculated using a dimensionless average pressure equation for P̅_{Dm}, and wherein the dimensionless average pressure equation for P_{Dm} comprises:
$${\overline{P}}_{Dm} = \frac{{\overline{P}}_{m} - {P}_{i}}{{P}_{f} - {P}_{i}} = erfc ( \frac{{L}_{m}}{\sqrt{4 {α}_{h} t}} ) + \frac{\sqrt{4 {α}_{h} t} ( 1 - {e}^{- {( \frac{{L}_{m}}{\sqrt{4 {a}_{h} t}} )}^{2}} )}{{L}_{m} \sqrt{π}}$$
wherein P_{f} is pressure at fracture, Pᵢ is initial matrix pressure, P̅ₘ is average pressure of a grid cell, A_{f} is the area of the fracture, M is a calibration factor, x is distance, t is effective simulation time, Lₘ is length of matrix block, erfc is complimentary error function, and αₕ is diffusivity coefficient.

13. The method of claim 9, wherein the second diffusivity-based transmissibility modification method uses the one-dimensional, single phase transient diffusion model with the effective simulation time as input to calculate a particular transmissibility value for a particular matrix-fracture connection in response to the ratio.

14. The method of claim 9, wherein the second diffusivity-based transmissibility modification method uses Embedded Discreet Fracture Modeling to calculate a particular transmissibility value for a particular matrix-fracture connection in response to the ratio.

15. A method of simulating fluid flow for a subsurface volume of interest that comprises at least one fracture, the method comprising:
a) obtaining a reservoir model for a subsurface volume of interest that comprises at least one fracture, wherein the reservoir model is in coarse scale, and wherein the reservoir model comprises a plurality of matrix-fracture connections; and
b) performing a simulation and generating simulation output using the obtained reservoir model to solve for fluid flow of the subsurface volume of interest that comprises the at least one fracture, wherein the simulation includes a plurality of time steps, and wherein for each time step of the simulation:
(i) obtaining simulation data for calculating a transmissibility for each matrix-fracture connection,
(ii) calculating the transmissibility for each matrix-fracture connection using the obtained simulation data and a machine learning-based transmissibility modification method, wherein the calculated transmissibility for each matrix-fracture connection changes over simulation time,
(iii) modifying a previous transmissibility of each matrix-fracture connection in the reservoir model with the corresponding transmissibility calculated using the machine learning-based transmissibility modification method, and
(iv) solving for fluid flow using the modified reservoir model.

16. The method of claim 15, wherein the machine learning-based transmissibility modification method uses a plurality of artificial neural networks, including a first artificial neural network and a second artificial neural network.

17. The method of claim 16,
wherein the first artificial neural network is in fine scale, and
wherein input for the first artificial neural network comprises matrix permeability, porosity, initial reservoir pressure, time step length, bottom hole pressure, initial bubble point pressure, Corey's exponents, compaction table multiplier, simulation time, or any combination thereof from the reservoir model, and
wherein output from the first artificial neural network comprises oil flow rate at fracture face, gas flow rate at fracture face, or any combination thereof.

18. The method of claim 17,
wherein the second artificial neural network is in coarse scale, and
wherein input for the second artificial neural network comprises matrix permeability), porosity, initial reservoir pressure, time step length, bottom hole pressure, initial bubble point pressure, Corey's exponents, compaction table multiplier, simulation time, or any combination thereof from the reservoir model;
wherein input for the second artificial network further comprises the oil flow rate at fracture face from the first artificial neural network, the gas flow rate at fracture face from the first artificial neural network, difference in pressure between matrix and fracture cells from the reservoir model, or any combination thereof, and
wherein output from the second artificial neural network comprises a particular transmissibility for a particular matrix-fracture connection.

19. The method of claim 18, wherein logarithmic sampling is utilized in training the first artificial neural network, the second artificial neural network, or any combination thereof.

20. The method of claim 18, wherein additional input for the first artificial neural network, the second artificial neural network, or any combination thereof comprises minimum transmissibility multiplier, pressure at max value of transmissibility multiplier, curvature, or any combination thereof from the reservoir model.
